(19) United States
(12) Patent Application Publication
(10) Pub. No.: US 2026/0316038 A1
(43) Pub. Date: Oct. 15, 2026

(54) Automated Reaction Apparatus

(71) Applicant: The University Court of the University of Glasgow, Glasgow, Strathclyde (GB)

(72) Inventors: Leroy Cronin, Glasgow, Strathclyde (GB); Nicola Bell, Glasgow, Strathclyde (GB)

(21) Appl. No.: 19/484,219

(22) PCT Filed: May 17, 2024
(86) PCT No.: PCT/EP2024/063784

§ 371 Date: Nov. 13, 2025

(30) Foreign Application Priority Data
May 17, 2023 (GB) 2307382.8

(51) Int. Cl. B01J 19/00

(52) U.S. Cl. CPC B01J 19/004; B01J 2219/00162; B01J 2219/00164; B01J 2219/00234

(57) ABSTRACT

The invention relates to an apparatus and methods for performing air-sensitive and/or water-sensitive reactions autonomously, for example with an automated chemical synthesiser. The automated chemical synthesiser comprises a first reactionware in fluid communication with a reagent manifold, a vacuum line and a gas line, wherein the synthesiser further comprises a control unit for automatically and independently controlling fluid communication of the reactionware with the reagent manifold, vacuum line and gas line, and the gas line is for the supply of anaerobic and/or anhydrous gas. The synthesiser is operable to provide an anaerobic and/or anhydrous environment, such as atmosphere, within a reactionware, such that chemical syntheses which are sensitive to oxygen and/or water may be performed in the reactionware.

### RELATED APPLICATION

The present application claims priority to, and the benefit of, GB 2307382.8 filed on 17 May 2023 (17.05.2023), the contents of which are hereby incorporated by reference in their entirety.

### FIELD OF THE INVENTION

The present invention relates to apparatus and methods for performing air-sensitive and/or water-sensitive reactions autonomously, for example with an automated chemical synthesiser.

### BACKGROUND

Manual inert atmosphere chemistry has developed hugely in the past 50 years due to the increasing availability of technologies such as positive-pressure gloveboxes, Schlenk lines and solvent purification systems (Gibb; Linn; Pangborn et al.; Alaimo et al.). In tandem, our ability to investigate and exploit species which hydrolyse or oxidise readily under atmospheric conditions has expanded rapidly. However, the manipulation of reactions under inert conditions still requires significant specialist training and many procedures fail due to poor technique (see, for example, Davis et al.; Lacy et al.). In addition, with manual handling it is significantly more challenging to carry out multiple inert reactions at one time limiting the number of new compounds which can be made, or the chemical space explored, meaning organometallic chemistry currently moves at a slower pace than its aerobic counterparts.

Several key features delineate inert-atmosphere chemistry from traditional bench techniques. Firstly, removal of air from the flasks and system in question by application of vacuum is required (Errington et al.; Synthetic Methods of Organometallic and Inorganic Chemistry). This is typically achieved using Schlenk glassware which has a manually sealable gas handling side arm. Reduced pressure of at least <0.1 mbar (<10 kPa) is required for the most sensitive chemistry to reduce the levels of O₂ and H₂O to sub ppm quantities. This effect is carried out using a Schlenk line or Inert Manifold which has two distinct lines, one for vacuum and one for inert gas, and several sets of taps which allow connection to the reactors or glassware in question. After evacuation and refill in triplicate (often known as cycling or inertization), to reduce remaining air to adequate levels the flasks can be maintained under positive pressure throughout a reaction by retaining connection to the inert gas line on the manifold.

There is a need for robust apparatus and methods for the performance of anaerobic and anhydrous chemical syntheses in a reproducible and reliable manner.

### SUMMARY OF THE INVENTION

In a general aspect, the invention provides an automated chemical synthesiser for anaerobic and/or anhydrous chemical synthesis.

In a first aspect, the invention provides an automated chemical synthesiser for anaerobic and/or anhydrous chemical synthesis, the synthesiser comprising a first reactionware in fluid communication with a reagent manifold, a vacuum line and a gas line, wherein the synthesiser further comprises a control unit for automatically and independently controlling fluid communication of the reactionware with the reagent manifold, vacuum line and gas line, and the gas line is for the supply of anaerobic and/or anhydrous gas.

The synthesiser may further comprise a second reactionware, wherein the second reactionware is in fluid communication with the reagent manifold, the vacuum line and the gas line, and the control unit is for automatically and independently controlling fluid communication of the second reactionware with the reagent manifold, vacuum line and gas line, wherein the second reactionware is in fluid communication with the first reactionware via the reagent manifold, and the second reactionware is isolable from the first reactionware.

In one embodiment, the reagent manifold comprises a valve in line with the fluid communication of one reactionware with another reactionware, wherein the valve is automatically operable to control fluid communication between the reactionware, and optionally the valve is in line with a reagent input, and the valve is automatically operable to independently control supply of the reagent input into a reactionware.

In a further embodiment, the synthesiser comprises a Schlenk line for independently providing to each reactionware vacuum from the vacuum line, gas from the gas line and to isolate the reactionware from the vacuum line and the gas line. Here, the Schlenk line may have valves for controlling the provision of vacuum and gas and for isolation control, and the valves are controllable by pressure change switching, such as low pressure switching.

In an additional embodiment, the Schlenk line may have one or more solenoid valves for controlling the provision of vacuum and gas to the reactionware and for isolation control of the reactionware. Each valve may be electronically controllable. The solenoid valves may be impulse solenoid valves, which are controlled by a pulse of polarised voltage. The Schlenk line may be a modular Schlenk line.

A reactionware in the synthesiser may have a port for delivery and removal of fluids to and from the reactionware, wherein the port holds a first fluid delivery line which holds a second fluid delivery line, and the first fluid delivery line is for vacuum from the vacuum line or gas from the gas line, and the second fluid delivery line is in fluid communication with the reagent manifold.

A gas line is for the supply of one or more of nitrogen, argon, carbon dioxide, hydrogen, oxygen, fluorine, chlorine, bromine, xenon, helium, neon, ozone, water vapour, hydrogen sulfide, anhydrous air, carbon monoxide, deuterium, ammonia, methylamine, dimethylamine, silane, methane, acetylene, phosphine, hydrogen chloride, and nitrous oxide. The gas line may supply gas which is substantially free of water and/or sustainably free of oxygen.

Typically, the gas line is for the supply of one or more of nitrogen, argon, carbon dioxide or hydrogen.

The gas line may be for the supply of gas at atmospheric pressure (101 kPa) or above, such as 150 kPa or more, such as 200 kPa or more, such as 300 kPa or more, such as 1,000 kPa or more. The water content of the gas from the gas line may be 100 ppm or less, such as 10 ppm or less, such as 1 ppm or less, such as 0.5 ppm or less, such as 0.1 ppm or less. The oxygen content of the gas from the gas line may be 100 ppm or less, such as 10 ppm or less, such as 1 ppm or less, such as 0.5 ppm or less, such as 0.1 ppm or less.

The vacuum from the vacuum line may be for providing a reduced pressure within a reactionware, such as a pressure of less than atmospheric pressure (101 kPa), such as a pressure of 50 kPa or less, such as 10 kPa or less, such as 1 kPa or less, such as 0.2 kPa or less, such as about 0.10 kPa or about 0.15 kPa.

The automated chemical synthesiser is suitably programmed for the control unit to autonomously control the atmosphere within a reaction space of the reactionware. The reaction space may have an anaerobic and/or anhydrous atmosphere and/or an atmosphere that is above or below atmospheric pressure.

A reactionware may be selected from the group consisting of a round-bottomed flask having one or more necks, a filter flask, a cuvette, an NMR tube, and a storage flask. Additionally the reactionware may be selected from a vial. A reactionware may be isolable from the reagent manifold, the vacuum line and the gas line. Further, a reactionware may be separable from fluid communication with the reagent manifold, the vacuum line and the gas line, and is optionally removable from the automated chemical synthesiser.

A reactionware may be provided with a cold surface, such as a cold finger, for the collection of sublimate, and the cold finger is a part of the reactionware and is separable from other parts of the reactionware.

In a second aspect there is generally provided the use of a chemical synthesiser for automatically preparing a reactionware for performing an anaerobic and/or anhydrous chemical synthesis, wherein the chemical synthesiser is an automated chemical synthesiser according to the first aspect of the invention. Also provided is the use the chemical synthesiser for automatically for performing an anaerobic and/or anhydrous chemical synthesis.

Thus, a method for performing an anaerobic and/or anhydrous chemical synthesis in an automated chemical synthesiser may comprises the step of:
(i) supplying under the autonomous control of the control unit, an anaerobic and/or anhydrous gas from the gas line to reactionware; or
(ii) applying a vacuum under the autonomous control of the control unit from the vacuum line to the reactionware.

The steps of applying vacuum and gas to the reactionware may be performed in turn, and may be performed repeatedly. Thus, the reactionware may be suitably prepared for anaerobic and/or anhydrous chemical synthesis by allowing for the removal of oxygen- and/or water-containing fluids, and typically gases, that are initially present in the reactionware. Such oxygen- and/or water-containing fluids, and typically gases, are then diluted with, such as entirely replaced with, anaerobic and/or anhydrous gas.

For the performance of an anaerobic and/or anhydrous chemical synthesis, the method may comprise the step (iii) of supplying to the reactionware, under the autonomous control of the control unit, one or more reagents, optionally together with catalysts and solvents, from the reagent manifold.

The reactionware may have been suitably prepared for anaerobic and/or anhydrous reaction by performing steps (i) and/or (ii) prior to the supply of the one or more reagents. Additionally, or alternatively, steps (i) and (ii) may be performed after the supply of the one or more reagents.

Where the one or more reagents, optionally together with catalysts and solvents, are provided to the reactionware, the method of the invention may comprise the step of (iv) of performing a reaction in a reaction space of the reactionware.

The methods of the invention may include the step of automatically measuring and/or controlling, under the autonomous control of the control unit, one or more of:
(a) the water content in the atmosphere of a reaction space of the reactionware;
(b) the oxygen content in the atmosphere of a reaction space of the reactionware;
(c) the pressure of the atmosphere of a reaction space of the reactionware.

Thus, the system can maintain the conditions within reactionware for the performance of an anaerobic and/or anhydrous chemical synthesis.

These and other aspects and embodiment of the invention are described in further detail below.

### SUMMARY OF THE FIGURES

FIG. 1 provides an overview of an embodiment of the automated chemical synthesiser of the invention, where a route map shows the liquid handling connections (thin lines) between the Chemputer backbone and reactors as well as gas/vacuum handling connections (thicker lines) between the inert manifold and the bespoke glassware designed in this work (left to right: Schlenk filter flask, green; Schlenk collection ampoule, teal; sealable UV/vis cuvette, orange; J Young NMR tube adaptor, yellow; 3-necked RBF appended with remotely operable Louwers Hanique tap, blue; Solvent storage ampoules with inert gas flow splitter, red). (G: Inert gas inlet; V: vacuum inlet; W: waste outlet).

FIG. 2 shows an embodiment of the automated chemical synthesiser of the invention. (a), Lowers Hanique taps open and close by application of a weak vacuum to the hollow of the glass tap; (b) Using these taps a remotely-operable, automated Schlenk line has been constructed which allows for the application of high vacuum (ca 1.5×10⁻³ mbar (0.15 Pa)) and high pressure N₂/Argon (ca. 1 bar overpressure to atmosphere) to reaction flasks; and (c) Chemical programming language commands have been developed to operate these taps.

FIG. 3 shows an embodiment of the automated chemical synthesiser of the invention for product isolation. (a) Glassware for the automated chemical synthesiser system including an inert atmosphere isolation flask and inert atmosphere filter flask; and (b) The tube-in-tube adaptor system which allows liquid and gas handling through one flask port.

FIG. 4 shows the synthesis of colorimetric indicator titanocene(III). a, Photograph of part of the automated chemical synthesiser manifold with Valve-Pump and Valve-Valve “dead” areas highlighted (yellow & green respectively); (b) Scheme showing Ti(IV) reduction with indicative solutions colours for different stages: (c) Colour of the product solution after passing through the fully inertized LH backbone: (d) XRD Crystal structure of isolated product from automated reaction; € Section of a XDL procedure showing the process of connecting and inertizing a flask and the liquid handling system and (f) Overview of the guided (semi-automated) reaction/platform setup process.

FIG. 5 shows the synthesis of cerium(III)tris(bis(trimethylsilyl)amine) (2) in two stages. (a) Moving from an aerobic to anaerobic and anhydrous synthetic space in the automated chemical synthesiser: (b) Setup for removal of solvent using an isolable cryogenic trap; and (c) Automated UV/vis solution sampling allowed for the spectroscopic analysis of the Ce(III) product.

FIG. 6 shows the synthesis and isolation of tris(pentafluorophenyl)borane, a highly hygroscopic Lewis acid. a, Reaction scheme for the synthesis of B(C₆F₅)₃; (b) Incorporation of an ultra-low temperature chiller unit allowed for automated reactivity at temperatures as low as −100° C.; (c) Inline low-field NMR analysis can detect formation of the desired product with no evidence of hydration; (d) schematic showing the setup and function of the automated evaporation and sublimation apparatus; and (e) photograph of the setup and glassware used for automated sublimation of B(C₆F₅)₃.

FIG. 7 shows an alkali metal reduction to generate Mg(I). a, Reduction of (NacNac)MgI with Na(0); (b) Risk mitigation steps for automated handling of pyrophoric and flammable species; and (c) Temperature change with different rates of quenching (rate determined by aliquot size) of Na(0) with iPrOH (15% in Toluene). Monitoring stopped upon observation of no further temperature increase.

FIG. 8 shows the visual representation of the hardware graph for the synthesis of [Cp₂Ti(CH₃CN)₂]₂[ZnCl₄]1.

FIG. 9 shows the visual representation of the hardware graph for the synthesis of CeN″3.

FIG. 10 shows the visual representation of the hardware graph for the synthesis of CeOTf₃.

FIG. 11 shows the visual representation of the hardware graph for the synthesis of B(C₆F₅)₃.

FIG. 12 shows the visual representation of the hardware graph for the synthesis of [(Dipp)NacNac}Mg]₂.

FIG. 13 shows a drawing of a solenoid manifold with outlet tubing to flasks (bottom left), AutoSchlenk gas line taps (bottom middle), and AutoSchlenk Vacuum Line Taps (bottom right).

FIG. 14 shows a drawing of an example modular Schlenk line. FIG. 14a is a perspective view of the example modular Schlenk line having 5 channel modules, a front plate and an end plate. FIG. 14b shows a schematic of the solenoid valves and the connection of the solenoid valves to vacuum, inert gas, and the output from the channel module. FIG. 14c shows a schematic (left) and perspective views (middle and right) of the channel module. FIG. 14d shows a schematic (left) and perspective views (middle and right) of the front plate (top) and end plate (bottom).

### DETAILED DESCRIPTION OF THE INVENTION

The present invention provides apparatus and methods for performing air-sensitive and/or water-sensitive reactions autonomously, for example with an automated chemical synthesiser.

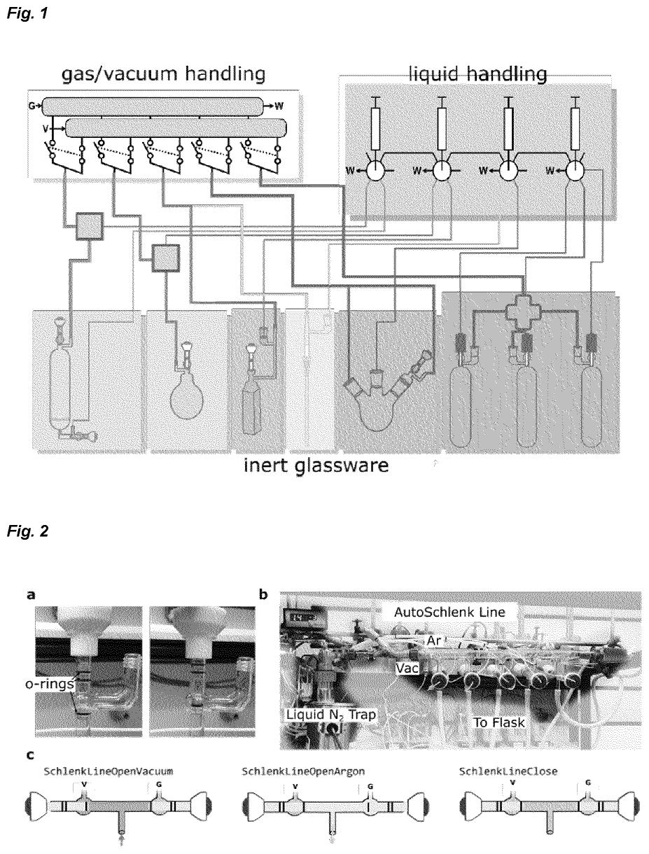

Thus, described herein is the design, development, and deployment of the first fully automated inert-atmosphere synthesis robot, or automated chemical synthesiser, known as the Schlenkputer, which can reach reduced pressures of 1.5×10⁻³ mbar (0.15 Pa) and allows for automated evacuation and refill of reactor flasks; a range of key glassware allowing for the sealing of the flask for the duration of our experiments; and the coupling of this inert-gas handling system with a liquid handling backbone Chemputer, see FIG. 1 (Steiner et al.; Burger et al.; Adamo et al.; Angelone et al.). Using this new system we demonstrate the complete automated synthesis of a range of sensitive compounds from across the periodic table including: the colorimetric indicator Cp₂Ti^{III}(MeCN)₂ (1), readily oxidisable Ce^{III}{N(SiMe₃)₂}₃ (2), highly moisture sensitive B(C₆F₅)₃ (3) and the alkali metal-reduced {DippNacNacMgI}₂ (4). Through the use of our Chemical Programming language (XDL) we are able to remotely program and conduct the synthesis, sampling and analysis of an entire reaction process whilst maintaining inert conditions (see Mehr et al.). In addition, we demonstrate the incorporation of in-line NMR spectroscopy, temperature sensing for safe quenching of alkali metal reagents, and reaction sampling for UV/vis analysis.

Automated systems for chemical synthesis, discovery and prediction have potential to revolutionise the chemical sciences. Bespoke equipment such as peptide synthesisers and preparative HPLC reduce the level of training, time and discipline specific skill required for routine tasks and increasing safety by minimising human contact with toxic reagents. Building on these advances recently there has been a drive towards more ‘universal’ synthesis machines which can undertake more of the operations automatically with minimal labour costs (Steiner et al.; Burger et al.; Adamo et al.).

Current chemical automation technologies focus strongly on aerobic transformations, often using liquid handling (LH) systems for low to medium scale synthesis. Whilst some of these systems incorporate basic inert atmosphere conditions control, these are normally rudimentary, are not programmable since they only can purge or blanket the system with inert gas. As such these approaches are inadequate for the majority of robust organometallic or air-sensitive chemistries which must be conducted at sub ppm levels of O₂ and H₂O (Angelone et al.; Armitage et al.). This means the use of automation at the forefront of highly reactive chemistry is severely underdeveloped (Malig et al.; Kleoff et al.).

US 2006/0014176 describes a reaction apparatus for performing solid-phase chemistry, such as polynucleotide synthesis. The apparatus is shown in FIG. 2, and includes a reaction vessel (10) that is linked to a reagent manifold (50). It may be provided with gas and fluids through inlets (16).

US 2006/0014176 does not demonstrate the use of the reaction apparatus in an automated system, and only describes a single reaction vessel, rather than multiple vessels linked in an automated platform for performing anaerobic and/or anhydrous chemical synthesis. As the document relates to solid phase synthesis, the device is configured to retain the solid phase in a single reaction vessel. The connections between the vacuum and gas lines and the reactor are not described. There is no explicit disclosure that the vacuum and gas lines are supplied to a single port of the reaction vessel together with the reagent line. The document does not describe a device which is configured to automatically and independently control fluid communication within the reaction vessel, and thus perform anaerobic and/or anhydrous chemical synthesis.

One of the present inventors has also previously described automated synthesisers, including fluid management systems. For example, WO 2021/209773 describes a fluid handling device with an array of interconnected multi directional valves, which is adapted for the delivery of reagents. However, this work does not describe a system for performing anaerobic and/or anhydrous chemical synthesis, and does not describe a device with vacuum or gas lines to the reaction vessels.

Accordingly, the present invention provides an automated chemical synthesiser for performing an anaerobic and/or anhydrous chemical synthesis. The synthesiser is operable to provide an anaerobic and/or anhydrous environment, such as atmosphere, with a reactionware, and chemical synthesis that are oxygen and/or water may be advantageously performed in the reactionware.

The synthesiser comprises a first reactionware in fluid communication with a reagent manifold, a vacuum line and a gas line, wherein the synthesiser further comprises a control unit for automatically and independently controlling fluid communication of the reactionware with the reagent manifold, vacuum line and gas line, and the gas line is for the supply of anaerobic and/or anhydrous gas.

### Automated Chemical Synthesiser

The automated chemical synthesiser may also be referred to as a programmable robot for automated chemical synthesis.

The automated chemical synthesiser first reactionware in fluid communication with a reagent manifold, a vacuum line and a gas line, wherein the synthesiser further comprises a control unit for automatically and independently controlling fluid communication of the reactionware with the reagent manifold, vacuum line and gas line, and the gas line is for the supply of anaerobic and/or anhydrous gas.

The apparatus within the synthesiser, and particularly the reactionware, the reagent manifold, vacuum line and gas line are capable of withstanding reduced pressures, such as those mentioned in the present case, and are capable of withstanding elevated pressure, such as those mentioned in the present case.

The synthesiser may be provided with safety valves in line with the reactionware to provide safety release where the reduced pressure or elevated pressure within the synthesiser approaches or exceeds limits. An analytical unit provided within the synthesiser may be used to monitor pressure within the apparatus of the synthesiser, and information may be provided to the control unit to operate the safety valves as required.

### Reactionware

A reactionware is an apparatus, such as a flask, for holding reagents, a reaction mixture, a product mixture or a product. The reactionware may have a reaction space for performing an anaerobic and/or anhydrous chemical reaction as part of an anaerobic and/or anhydrous chemical synthesis.

A reactionware may be selected from the group consisting of a reaction flask having one or more necks, a filter flask, a cuvette, an NMR tube, and a storage flask. Additionally, the reactionware may be selected from a vial.

A reactionware may be provided with a cold surface, such as a finger, for the collection of sublimate, and the cold surface, such as the finger, is a part of the reactionware and is separable from the other parts of the reactionware.

A reactionware may be provided with suitable apparatus for providing physical, including mechanical inputs to the contents of the reactionware, such as the contents of a reaction space. Each of these inputs is controllable by the control unit.

Thus, the reactionware may be provided with heating or cooling apparatus, mechanical agitation devices, including stirrers and shakers, irradiative devices, such as light and microwave devices, and ultrasound apparatus.

The chemical synthesiser has a first reactionware in fluid communication with a reagent manifold, a vacuum line and a gas line, wherein the synthesiser further comprises a control unit for automatically and independently controlling fluid communication of the reactionware with the reagent manifold, the vacuum line and the gas line.

The chemical synthesiser may have a second reactionware. The second reactionware may be provided for receiving material, such as a product or a product mixture from the first reactionware, where the product or product mixture results from a chemical reaction performed in the first reactionware. The second reactionware may be used for the purification of the product or a product mixture. Additionally or alternatively, the second reactionware may be used for the performance of a further chemical reaction, where the product or product mixture from the first reactionware is a reagent for the chemical reaction performed in the second reactionware.

Where the synthesiser further comprises a second reactionware, the second reactionware is in fluid communication with the reagent manifold, the vacuum line and the gas line, and the control unit is for automatically and independently controlling fluid communication of the second reactionware with the reagent manifold, the vacuum line and the gas line. The second reactionware is in fluid communication with the first reactionware via the reagent manifold.

The second reactionware is isolable from the first reactionware. Thus, fluid communication between the first and second reactionware may be prevented as needed.

The chemical synthesiser may have further reactionware in addition to the first and second reactionware. Where there are further reactionware each of these may be independently provided for receiving material, such as a product or a product mixture from the first and/or second reactionware, where the product or product mixture results from a chemical reaction performed in the first and/or second reactionware.

Additionally or alternatively, the further reactionware may be independently used for the performance of a further chemical reaction, where the product or product mixture from the first reactionware and/or the second reactionware is a reagent for the chemical reaction in the further reactionware.

Where the synthesiser further comprises one or more further reactionware each of the one or more reactionware is independently in fluid communication with the reagent manifold, the vacuum line and the gas line, and the control unit is for automatically and independently controlling fluid communication of each of the one or more reactionware with the reagent manifold, vacuum line and gas line. Each of the one or more reactionware is in fluid communication with the first and/or the second reactionware via the reagent manifold. Each of the one or more reactionware is isolable from the first and/or second reactionware. Thus, fluid communication between the first and second and further reactionware may be prevented as needed.

A reactionware is in fluid communication with the reagent manifold. Accordingly, one or more reagents, and/or one or more solvents or catalysts, may be fluidically delivered to a reactionware from the manifold.

The manifold is also provided for fluid communication of material between reactionware, as descried in further detail below. Thus, material in one reactionware is fluidically deliverable to another reactionware, as automatically controlled by the control unit. The control unit operates the vacuum and gas lines to provide pressure differential between reactionware to allow for the transfer of materials, for example from regions of higher pressure to regions of lower pressure. In this way, the reagent manifold acts a fluid handling manifold within the synthesiser.

A reactionware is in fluid communication with the vacuum line and the gas line. The vacuum line and gas line may be used to remove material from a reactionware, such as water and/or oxygen, but may also be used to facilitate the transfer of materials to and from reactionware, and to and from the reagent manifold as described herein. These transfers are performed automatically under the control of the suitably programmed control unit that is executing an instruction set for a chemical synthesis. Thus, the transfer of material through the system, ether for purification, isolation or for onward use in subsequent chemical reactions, is performed without the requirement for user input.

The reactionware may be provided with multiple ports, such as necks, where the ports may be variously and separately used to provide vacuum from the vacuum line, gas from the gas line, reagents from the reagent manifold, and to remove components from the reactionware.

However, in some embodiments, a single port may be used to provide vacuum from the vacuum line, gas from the gas line, reagents from the reagent manifold, and to remove components from the reactionware. This can allow for simplification of the reactionware, and allow for easier separation and addition of the reactionware to the inline fluid communication.

In one embodiment, a reactionware has a port for delivery and removal of fluids to and from the reactionware, wherein the port holds a first fluid delivery line which holds a second fluid delivery line, and the first fluid delivery line is for vacuum from vacuum line or gas from the gas line, and the second fluid delivery line is in fluid communication with the reagent manifold.

In this embodiment, the fluid communication with the reagent manifold, and the fluid connection with gas line and vacuum line can be managed through a single port. This reduces the complexity of the system and the requirement for multiport reactionware. Where the number of ports in a reactionware is minimised, the opportunity for leakage or ingress is minimised. For example, there is reduced opportunity for ingress of water or oxygen through port seals as the number of part seals is kept to a minimum.

A reactionware is isolable from the reagent manifold, the vacuum line and the gas line. Thus, a valve may be provided to isolate that reactionware from the supply of vacuum, gas or reagents other material from the reaction line. Thus, an environment for the reactionware that is separate to the rest of the synthesiser is achievable.

Following from this, a reactionware may also be separable from fluid communication with the reagent manifold, the vacuum line and the gas line, and is optionally removable from the automated chemical synthesiser. Thus, reactionware can be swapped in and out of the automated chemical synthesiser as needed.

### Vacuum Line and Gas Line

The automated chemical synthesiser is provided with a vacuum line for providing a vacuum to a reactionware. Thus, the vacuum line is in fluid communication with a reactionware.

The vacuum line is for providing a reduced pressure within a reactionware, such as a pressure of 50 kPa or less, such as 10 kPa or less, such as 1 kPa or less, such as 0.2 kPa or less, such as about 0.15 kPa.

The automated chemical synthesiser is provided with a gas line for providing a gas to a reactionware. Thus, the gas line is in fluid communication with a reactionware.

In one embodiment, the gas line is for the supply of one or more of nitrogen, argon, carbon dioxide or hydrogen. Typically, the gas line is for the supply of nitrogen or argon.

The gas line may be for the supply of gas at atmospheric pressure or above, such as 50 kPa or more, such as 200 kPa or more, such as 300 kPa or more. It is clearly understood that the pressure of the gas in the gas line is greater than the pressure in the vacuum line.

The gas line is for the supply of anaerobic and/or anhydrous gas, such as anaerobic and anhydrous gas.

The gas line may be for the supply of gas having a water content of 100 ppm or less, such as 10 ppm or less, such as 1 ppm or less, such as 0.1 ppm or less.

The gas line may be for the supply of gas having an oxygen content of 100 ppm or less, such as 10 ppm or less, such as 1 ppm or less, such as 0.1 ppm or less.

The vacuum line and gas line may be provided in a combined apparatus for the controlled and independent provision of vacuum and gas. The vacuum line and gas line may be part of a Schlenk line, which Schlenk line is automatically operable under the control of the control unit.

The Schlenk line is for independently providing to each reactionware, vacuum from the vacuum line and gas from the gas line and to isolate the reactionware from the vacuum line and the gas line. A valve is provided for the Schlenk line to independently provide vacuum from the vacuum line and gas from the gas line and to isolate the reactionware from the vacuum line and the gas line.

In some embodiments the Schlenk line has one or more valves for controlling the provision of vacuum and gas, and for isolation control. Each valve may be a solenoid valve controllable by electronic signalling. In some embodiments the Schlenk line comprises two valves per line, and the two valves are configured to control the provision of vacuum and gas, and for isolation control.

In some embodiments the Schlenk line comprises a first and a second valve in series, such as first and second solenoid valves. The first valve may be configured to control the provision of vacuum and gas. The second valve may be configured to provide isolation control.

The solenoid valves may be impulse solenoid valves. That is, the solenoid valves only change position when signalled. The solenoid valves are typically controllable from the control unit. The solenoid valves are operable to change position under the automatic control of the control unit.

The valves may have an inert gas inlet, a vacuum inlet, and an outlet connected to the reactionware. Thus, the valves may have only three connections.

A first valve is connected to a vacuum line and a gas line as inlets, and is connected to a second valve as the outlet. The first valve can provide a vacuum from the vacuum line and gas from the gas line to the second valve. The second valve is fluidically connected to the first valve as the inlet and the reactionware as the outlet. The second valve can provide the vacuum or gas from the first valve when open, or can isolate the reactionware from the vacuum line and the gas line when closed.

The valves may be a 3/2 valve or a 2/2 valve, such as a 3/2 solenoid valve or a 2/2 solenoid valve. A 3/2 solenoid valve is typically a valve having three connections (e.g., two inlets and one outlet) and two positions. The 3/2 valve may be connected to an inert gas line for one connection and a vacuum line for another connection. The third connection may be an outlet to the reactionware, or preferably a connection to a 2/2 solenoid valve (which is in turn connected to the reactionware). A 2/2 solenoid valve is a valve having two connection (e.g., one inlet and one outlet) and two positions. The 2/2 valve may have an connection to the outlet of the first valve, and a connection to the reactionware.

In some embodiments the Schlenk line is a modular Schlenk Line, comprising one or more Schlenk modules, such as two or more Schlenk modules. Each Schlenk module may comprise two solenoid valves, as described above. Each Schlenk module may be connected to the same vacuum line and gas line. Each Schlenk module may be independently connected to a separate reactionware.

A Schlenk line may be in fluid connection with two or more reactionware, and an independent fluid line is provided to each reactionware. Each fluid line is for providing vacuum or gas to a reactionware, independently from the other lines, and is operable to do so under the automatic control of the control unit. Accordingly, the Schlenk line is provided with a valve for each line in communication with a reactionware, which valve is independently operable to provide vacuum from the vacuum line, gas from the gas line and to isolate the reactionware from the vacuum line and the gas line. Additionally, the Schlenk line may be provided with a first and second valve (e.g., in series) for each Schlenk module, and for each Schlenk module in communication with a reactionware, the valves are independently operable to provide vacuum from the vacuum line, gas from the gas line and to isolate the reactionware from the vacuum line and the gas line.

The Schlenk line may have multiple valves, such as two or more valves, such as three or more valves, such as five or more valves.

The valves may be controllable by pressure change switching, such as low pressure switching. The synthesiser may use bleed lines from the gas line and/or vacuum line for control of the pressure switches.

Additionally, the valves may be controllable electronically, such as using electronic signalling, such as using a pulse of polarised voltage. The electronically controllable valves may be solenoid valves.

### Reagent Manifold

The reagent manifold is for the delivery of reagents to reactionware. This includes the supply of reagents to each reactionware in the automated chemical synthesiser.

The reagent manifold is for use in the transfer of components from one reactionware in the automated chemical synthesiser to another.

A reagent may be a reagent for reaction in a chemical reaction. A reagent may be sensitive to oxygen and/or water. That is, a reagent may be prone to decomposition in the presence of oxygen and/or water.

The reagent manifold may also be for the delivery of other components for use in a chemical reaction, most notably a solvent or a catalyst.

The reagent manifold may be provided with reservoirs for holding reagents, solvents and catalysts. Each reservoir is in fluid communication with a reactionware, and a valve is provided in line with the reservoir to control its supply to a reactionware.

The transfer of material from a reservoir may be undertaken using vacuum or gas from the vacuum and gas lines, as appropriate, under the automatic control of the control unit.

### Fluid Communication

A reactionware is in fluid communication, including liquid communication, with a reagent manifold, a vacuum line and a gas line.

Where there are multiple reactionware, these may also be in fluid communication. Typically, and preferably, these reactionware are in fluid communication via the reagent manifold. In some embodiments, reactionware may be in direct fluid communication.

Typically, fluid communication is achieved by the interlinking of apparatus within the synthesiser with piping (tubing) that is suitable for providing vacuum and/or for suppling gas, such as at increased pressure. The automated chemical synthesiser may possess a network of fluid lines, where controllable multiway valves provide interconnections between lines, and allow for multiple alternative flow paths between reactionware, the reagent manifold, the vacuum line and the gas line. The distribution possibilities for chemicals and products through the system is maximised, and the accessibility of multiple reactionware is made easy.

Valves may be provided in line on any fluid communication to allow fluid passage to be restricted or prevented. Such may also be used to control the passage of fluids through the synthesiser by creating fluid pathways, by judicious and appropriate opening and closing of valves within a network of fluid passageways. These valves are under automatic control, operable by the control unit.

Typically, one or more valves are provided in the reagent manifold, as it is the reagent manifold that is for use in controlling the distribution of reaction components, such as reagents, to and from reactionware, including between reactionware.

### Control Unit

The synthesiser is provided with a suitably programmed control unit for automatically undertaking a chemical synthesis within the synthesiser. The control unit is programmed to operate the reagent manifold, the vacuum line and the gas line thereby to control the chemical materials that are provided to and/or removed from the reactionware. It is within the reactionware that a step in the anaerobic and/or anhydrous chemical synthesis is performed.

Generally, the control unit is programmed to automatically operate valves within the synthesiser to permit fluid flow between the reactionware and each of the reagent manifold, vacuum line and gas line. The control unit is also suitably programmed to permit fluid flow within the reagent manifold, for example to allow for fluid flow between separate reactionware, such as the first and second reactionware.

The control unit is suitably programmed to autonomously control one or more of the water content in the atmosphere of a reaction space of the reactionware; the oxygen content in the atmosphere of a reaction space of the reactionware; and the pressure of the atmosphere of a reaction space of the reactionware. Thus, the control unit can maintain the integrity of the reactionware for an anaerobic and/or anhydrous chemical synthesis that is performed by the automated chemical synthesiser.

Thus, the control unit may measure and/or control one or more of:
(a) the water content in the atmosphere of a reaction space of the reactionware;
(b) the oxygen content in the atmosphere of a reaction space of the reactionware;
(c) the pressure of the atmosphere of a reaction space of the reactionware.

The control unit may receive data on water or oxygen content, or pressure, from suitable analytical sensors provided in the analytical unit. The control unit may control water or oxygen content, or pressure, by appropriate supply of vacuum or gases to the reaction space, thereby to alter the pressure in the reaction space, and/or to alter the water and/or oxygen content in the atmosphere of a reaction space.

The control unit may be provided with, or may be capable of constructing, a hardware graph that is a representation of the apparatus available for use in a chemical synthesis, together with the fluid interconnections between apparatus. The hardware graph may be supplemented with a chemical reagent graph, that is an indication of the reagents, as well as solvent and catalysts, that are available for use in a chemical synthesis, and this graph may also provide an indication of where in the hardware graph the reagent is located or is locatable.

The control unit is provided with an instruction set which is executable code for undertaking a chemical synthesis. Multiple instruction sets may be available for user selection, and each of these may be performed automatically by the synthesiser.

The control unit may make available for selection by the user only those chemical syntheses that may be automatically performed by the synthesiser. Typically, those chemical syntheses are those for which the synthesiser has the appropriate reaction apparatus, such as the appropriate reactionware. This selection may also account for the chemical inputs, such as reagents, solvents and catalyst, available to the synthesiser such as provided in the reagent manifold, as well as the physical inputs, such as heating, cooling, irradiation, and ultrasound, where these are available.

However, the control unit may make available for selection chemical syntheses that cannot be performed by the synthesiser. However, if selected, the control until will provide instructions to the user as to the apparatus that is to be added into the synthesiser, and the fluid connections that are to be made to bring the apparatus into line with apparatus that is a part of the synthesiser.

Typically, the instruction sets are not limited by the availability of reagents. The user will generally be able to supply suitable regents, and also solvents and catalysts to the synthesiser, and suitable instructions will be provided by the synthesiser to the user as to the appropriate manner and location for introducing these to the synthesiser. For example, reagents may be provided in a reactionware that is connected into the synthesiser, and/or reagents may be provided as a reagent input in the reagent manifold. Solvents and catalysts may be similarly supplied in this way.

A control unit may be in communication with a database, such as remote database, for supply of an instruction sets on demand, such as on the demand of a user. Thus, the control unit may have a list of available chemical syntheses, and the detailed executable instruction set, together any associated hardware requirements, chemical input requirements and physical input requirements, can be called from the database and presented to the user.

The control unit is capable of receiving analytical data from the analytical unit, and may make control decisions for a chemical synthesis based on the analytical data received from the analytical unit.

### Analytical Unit

The automated chemical synthesiser may be provided with an analytical unit for analysing chemical reaction components within the automated chemical synthesiser, such as within the reactionware.

The operation of the analytical unit is under the control of the control unit, and the analytical unit is operated automatically.

Analytical data is provided to the control unit of the synthesiser, where it may be analysed. The data may be used to characterise or confirm the identify of a reaction product, or to otherwise provide characterising information on a chemical rection performed in a reactionware.

The control until may autonomously make automatic control decisions based on analytical data received during a chemical synthesis or after a chemical synthesis is complete. These control decisions may relate to adaptation of a chemical synthesis whilst the synthesis is underway, or may relate to adaptations of a work-up and purification procedure.

The analytical unit may comprise one or more pressure sensors, which pressure sensors are for measuring the pressure in one or more reactionware, such as each reactionware. Pressure sensors may also be provided in line with the gas line and the vacuum line. This may be used for safety proposes to understand the pressures in the system, and to provide control for those pressure for safety reasons, for example.

The analytical unit may comprise a water sensor for determining the water content in a reactionware, such as the atmosphere of a reaction space of the reactionware. The analytical unit may comprise an oxygen sensor for determining the water content in a reactionware, such as the atmosphere of a reaction space of the reactionware.

### Methods and Uses

The present invention provides methods of chemical synthesis, where a step in the chemical synthesis is performed in a reactionware of an automated chemical synthesiser of the invention. The step in the chemical synthesis may be performed, and is preferably performed, under anaerobic and/or anhydrous conditions. Thus, the methods of the invention are suitable for water-sensitive and air-sensitive chemistries.

The present invention also provides the use of the chemical synthesiser of the invention for automatically performing an anaerobic and/or anhydrous chemical synthesis.

The methods of the invention generally include the step of preparing a reactionware for a chemical synthesis, wherein the method includes application of a vacuum from the vacuum line to the reactionware of an automated chemical synthesiser of the invention, followed by the supply of anaerobic and/or anhydrous gas from the gas line to the reactionware. The cycle of applying vacuum and subsequently supplying gas may be repeated, such as repeated one, two or three times. In this way, the amount of water or oxygen in the reactionware can be minimised. Such steps are common in classical chemical synthesis, and these steps may be performed automatically by the automated chemical synthesiser. In the present case, the synthesiser is capable of automatically monitoring conditions within the reactionware (such as pressure, and water and oxygen content) and the cycling can be repeated until satisfactory anaerobic and/or anhydrous conditions are achieved.

The cycle of applying vacuum and supplying gas supply may occur before the reactionware is supplied with a reagent from the reagent manifold. In this way the reactionware is readied to receive a regent that may be water or oxygen sensitive.

The cycle of applying vacuum and supplying gas supply may occur where one or more reagents is already present in the reactionware. These reagents—which are typically solids—may be retained in the reactionware during the cycle.

Prior to any cycle of applying vacuum and supplying gas, a reactionware may be cooled, and likewise the reagents within the reactionware. This is particularly helpful where the reactionware contains fluid, such as liquids, and it is not intended for these to be removed from the reactionware during the application of the vacuum. Cooling and subsequently warming the reactionware during gas supply, or later, is performed autonomously.

The methods of the invention may also include a step of transferring the contents of one reactionware, such as a first reactionware, to another reactionware, such as a second reactionware, in the automated chemical synthesiser. Here, the reactionware are placed in fluid communication and gas is supplied to the first reactionware at positive pressure to cause the displacement of components within the first reactionware to the second reactionware.

The automated chemical synthesiser of the invention is for use in anaerobic and/or anhydrous chemical synthesis. However, the automated chemical synthesiser may also be used to perform syntheses that are not particularly oxygen and/or water sensitive. The synthesiser may be used for such syntheses on the basis that the system allows for a chemical synthesis to be performed under controlled conditions where the oxygen and/or water levels are known, and are reproducible in other systems. Thus, the automated chemical synthesiser provides for standardised conditions, which may be copied by other synthesisers where reliability is desirable for a synthesis.

### Other Options

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described. Where technically appropriate embodiments may be combined and thus the disclosure extends to all permutations and combinations of the embodiments provided herein.

Certain aspects and embodiments of the invention will now be illustrated by way of example and with reference to the figures described above.

### EXAMPLES

The following examples are provided solely to illustrate the present invention and are not intended to limit the scope of the invention, as described herein.

### 1 Chemistry

### 1.1 General Experimental

All reactions were carried out under inert atmosphere using the technology described herein to evacuate and refill glassware with N₂ gas cylinder purging throughout the reaction.

Unless otherwise stated isolated sensitive materials were stored and prepared for offline NMR & XRD analysis in a nitrogen atmosphere MBraun Labstar Glovebox with O₂ levels <1 ppm and H₂O levels <2 ppm. Solvents (excepting hexane) were obtained from an SPS system and dried over activated 3 Å molecular sieves for 48 h after collection. Anhydrous hexane solvent was purchased from Sigma Aldrich and stored over activated 3 Å molecular sieves under nitrogen. Deuterated solvents for NMR analysis were dried over activated 3 Å molecular sieves. NacNacDippligand was prepared manually by a published method (see Crockett et al.). Anhydrous Cerium Triflate for the synthesis of Ce(N{SiMe₃}2)₃ was kindly provided by Tajrian Chowdhury from the group of Dr Joy Farnaby and prepared manually by their method, prior to the automated synthesis of CeOTf₃ described below.

Unless otherwise stated all other reagents were purchased from Sigma, Acros, Alfa Aesar, Fisher or Fluorochem and used as received.

Inline NMR spectra were collected on Spinsolve 43 Carbon from Magritek at a frequency of 43 MHz while full offline spectra were collected on a on a Bruker Avance III HD 600 MHz or Bruker Avance II 400 MHz spectrometers. Chemical shifts (6) are reported in parts per million (ppm) downfield from tetramethylsilane and for offline samples are referenced to residual protium in the NMR solvent (C₆D₆, δ=7.16; THF-d8, δ=3.58).

X-ray crystal structures of compounds 1 and 4 were collected on a Bruker Apex-II diffractometer and confirmed to match CCDC 1167669 (1) and CCDC 661566 (3) in the CSD. Chilling was provided by a Huber TC100E cooling system.

### 1.2 Synthesis of [Cp₂Ti(CH₃CN)₂]₂[ZnCl₄](1)

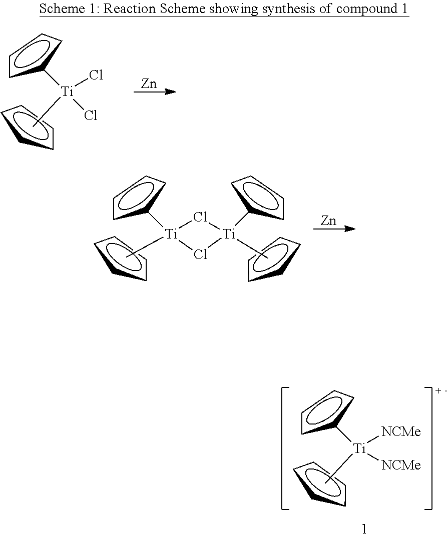

The following procedure was carried out without the use of an inert atmosphere glovebox at any point.

Following an adapted literature procedure (Seewald et al.), 8.3 g (29.7 mmol, 1 eq.) of Cp₂TiCl₂ was suspended in a mixture of 75 mL THF and 35 mL MeCN under nitrogen. The red solution was then rapidly added to a flask containing Zn dust (2.3 g, 35.2 mmol) and the resulting suspension was stirred for 30 minutes. During this time, the initial red solution turned dark blue. The filtered solution was transferred to a filter flask, and the solution layered with diethyl ether (170 mL). The flask was sealed and allowed to stand for 48 h leading to the precipitation of compound 1 as dark blue crystals (5 g, >43%). In order to extract crystals for X-ray diffraction, Fomblin Y Oil was added to the flask to allow their handling in air.

Screening experiments determined the unit cell parameters to be a=28.4, b=15.2, c=15.4 for an Orthorhombic cell with V=6,648 Å³ matching CSD entry 1167669 (Seewald et al.). Crystal Data for Compound 1: a=28.4 Å, b=15.2 Å, c=15.4 Å, α=β=γ=90°, orthorhombic, Pbca.

### 1.3 Synthesis of Ce(N(SiMe₃)₂)₃ (2)

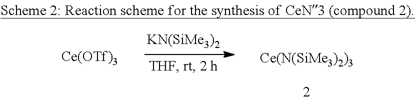

Ce(Otf)₃ (0.5 g, 0.867 mmol, 1.0 equivalent) and KN(SiMe₃)₂(KN″, 540 mg, 2.707 mmol, 3.1 equiv.) were weighed into a J-Youngs tapped ampoule in the glovebox. THF (10 mL) was added to suspend the reagents and a slow colour change from colourless to pale yellow was observed. The mixture was stirred at room temperature for 2 hours before being transferred into a second flask with washing with THF (10 mL). Subsequently, the THF was distilled into a cryogenic trap for 16 h before the orange residue was extracted into hexane (3×10 mL) and transferred through a filter tipped tube into a collection flask. The extractions in hexane were pumped down yielding a yellow powder CeN″₃ (187 mg, 35%).

Analytical data was consistent with literature reported values for [Ce(N(SiMe₃)₂)₃)](Gompa et al.; Yin et al.). ¹H NMR (C₆D₆): δ−3.36 (54H, s, Ce(N(SiMe₃)₂)₃) ppm. A small amount of HN″ impurity (δ 0.10, ~3.8%) was also present.

### 1.3.5 Synthesis of CeOTf₃—Testing Handling of Corrosives in System

Following a literature procedure an RBF was charged with Ce₂(CO₃)₃·xH₂O (1.5 g, 3.26 mmol, 1 equiv.) and suspended in 20 mL of deionised water (Sofield et al.). Neat HOTf (2 mL, 22.6 mmol, 6.9 equiv.) was added to the suspension, with stirring, resulting in an immediate vigorous fuming of the solution. The reaction mixture was refluxed at 101° C. for 18 hours under a flow of N₂. After 18 hours all solids had dissolved, leaving a colourless solution. Water was removed and the white solids were washed with Et₂O (4×10 mL) and hexanes (2×10 mL), and dried at 220° C. for 36 hours; yielding a whitish free flowing powder. The complete removal of water was confirmed by the absence of the key —OH band at 1657 cm⁻¹ which is present in the hydrated salt upon rapid IR analysis of the solid material by ATR-IR in air (Sofield et al.). Semi-automated NMR sampling of the white solids in dry MeCN into a J-Youngs NMR tube containing a capillary of d₃-MeCN showed only solvent in the ¹H spectrum and a single 19F resonance at −74.1 ppm (CeOTf₃).

### 1.4 Synthesis of B(C₆F₅)₃ (3)

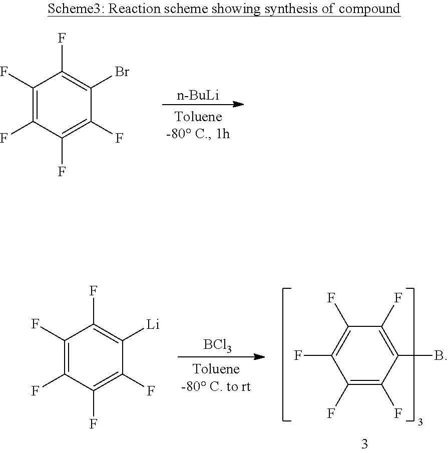

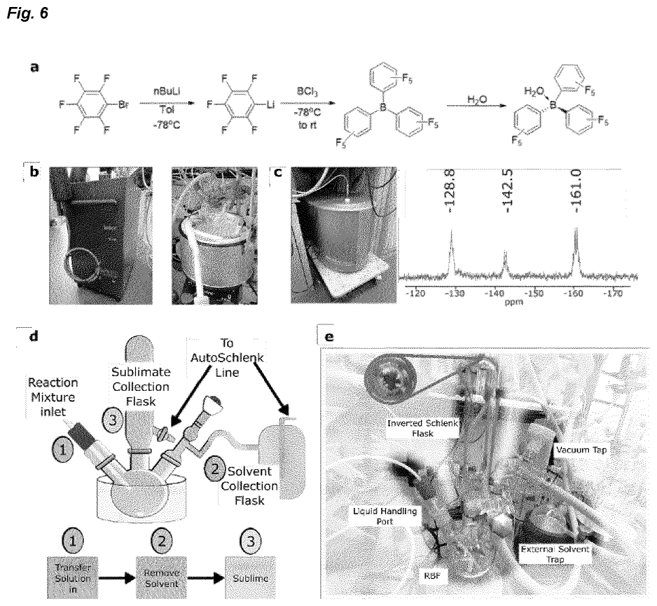

Following an adapted literature procedure (Fischer et al.), to a stirred solution of bromopentafluorobenzene C₆F₅Br (1.6 mL, 12.8 mmol) in toluene (5 mL), n-BuLi (1.6 M in hexanes, 7.8 mL, 0.162 mol) was added dropwise at −80° C. over a period of 7.8 minutes followed by further addition of toluene (5 mL) to ensure complete washing of the n-BuLi from the liquid handling tubing. The resulting colourless suspension was stirred for one hour at this temperature. A boron trichloride/n-hexane solution (4.2 mL, 1 M, 4.2 mmol) was then added within 50 seconds before further washing of the liquid handling tubing with toluene (5 mL) and the resulting colourless suspension was then slowly warmed to ambient temperature over a period of 90 mins. In situ ¹⁹F NMR analysis was conducted by transferring 10 mL of the reaction mixture to the NMR machine's flow cell to confirm conversion. The whole solution was then transferred through a frit to a 3-necked round bottomed flask appended on one neck with an inverted Schlenk tube and on a second attached to an independent solvent trap through a remotely operable Lowers Hanique tap (see FIG. 6). The solvent was distilled into the cryogenic solvent trap under reduced pressure, resulting in a yellowish residue. The solid residue was sublimed into the inverted Schlenk Flask at 100° C. yielding B(C₆F₅)₃ (840 mg, 38%) as a colourless, needle-like solid.

Analytical data was consistent with literature values for anhydrous B(C₆F₅)₃ (Fischer et al.; Bismuto et al.).

¹⁹F NMR (C₇H₈, 43 MHz) δ−128.8 (m, 6F), −142.5 (m, 3F), −160.5 (m, 6F) ppm; (C₆D₆, 376 MHz) δ−128.8 (m, 6F), −141.6 (m, 3F), −160.0 (m, 6F) ppm; ¹¹B NMR (C₆D₆, 160 MHz) δ−58.6 (br. s) ppm.

### 1.5 Synthesis of [(Dipp)NacNac}Mg]₂ (4)

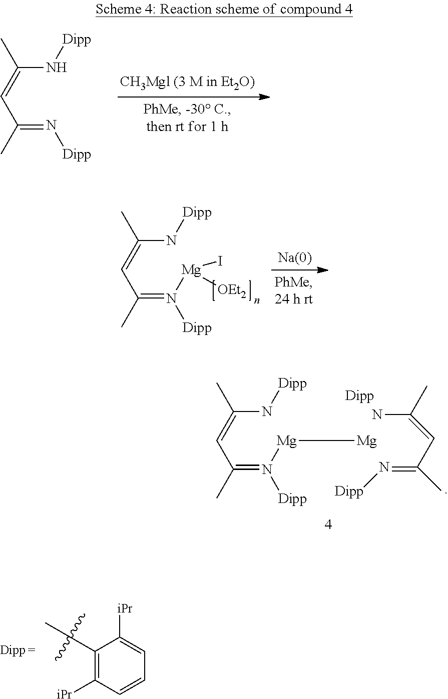

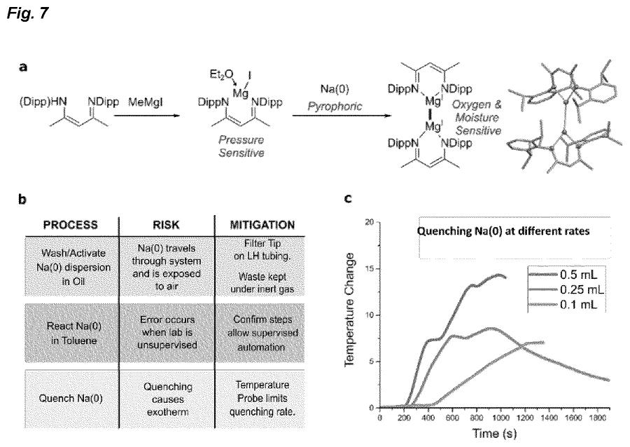

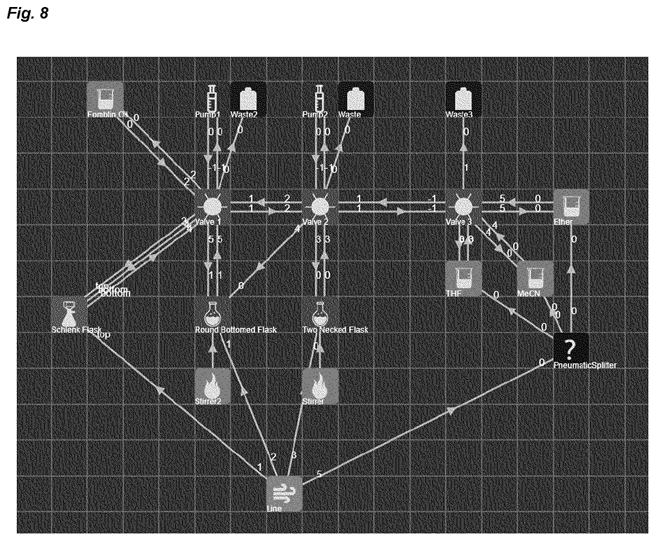

Starting material DippNacnacH was prepared according to a method reported in literature (Woof et al.). Under nitrogen, MeMgI (0.68 mL, 3.0 M in Et₂O, 2.05 mmol) was added to a stirred solution of DippNacnacH (715 mg, 1.71 mmol) in toluene (37 mL) at −30° C., followed by addition of a further aliquot of toluene (7 mL). The {DippNacnacMgI(OEt₂)}solution was allowed to reach room temperature yielding a colourless precipitate. Meanwhile a separate 3-neck round bottom flask, appended with a temperature probe, was charged with a sodium in oil dispersion (ca 9 mL, 40% w/w Na(0)) and washed with hexane (3×20 mL) with stirring before addition of the toluene suspension to this flask. This suspension was stirred for 20 h at RT after which time the solution was filtered and the solvent removed yielding a dark residue which was redissolved in hexane, filtered and the solvent removed under reduced pressure to give [(DippNacNac)Mg]₂ (328 mg, 43%) as a dark yellow solid. A solution of isopropanol (15% in toluene) was added slowly to the flask containing Na(0), maintaining the temperature below 50° C. in 0.25 mL aliquots. The temperature change with different aliquot addition volumes (0.1-0.5 mL between temperature readings) was recorded for different experiments and is shown in FIG. 7. NMR data was consistent with literature values for compound 4 (Green et al.).

¹H NMR (C₆D₆, 400 MHz) δ 7.07 (m, 12H, m-CHAr & p-CHAr), 4.82 (s, 2H, NC(CH)CN), 3.07 (sept., 8H, CH(CH₃)₂), 1.54 (s, 12H, NC(CH₃)), 1.16 (d, 24H, (CH₃)CH(CH₃)), 0.98 (d, 24H, (CH₃)CH(CH₃)); (d8-THF, 400 MHz, recrystallised) 67.00 (m, 12H, m-CHAr & p-CHAr), 4.70 (s, 2H, NC(CH)CN), 3.19 (sept., 8H, CH(CH₃)₂), 1.55 (s, 12H, NC(CH₃)), 1.05 (dd, 48H, CH(CH₃)₂).

Analytically pure crystals for XRD analysis and d8-THF NMR were grown from slow cooling of a hexane solution to −30° C. in a glovebox freezer and the unit cell was confirmed to match the previously reported species [(DippNacNac)Mg]₂ (Green et al.).

### 2 Hardware

### 2.1 AutoSchlenk Line

The manifold consists of two glass lines each appended with 5 Louwers Hanique Taps through a glass connection providing a hose barb from which to attached Portex tubing to a Schlenk flask. Each line is terminated with a female 19/26 Rodavis joint. The vacuum line (front) is thus connected to a straight J-Youngs tapped joint which allows connection to the Edwards RV5 vacuum pump through a cryogenic trap consisting of a 34/35 Rodavis connection. The gas line is appended on both ends with a straight HP Rotaflo keyed 3 mm joint. Finally the RHS terminus of the line is connected to an Edwards Pirani Vacuum Gauge through a Leybold Adapter Flange.

Louwers Hanique taps are connected to the programmable solenoid manifold (see below) with ⅛″ PTFE tubing via a Flangeless fitting connected through an Idex Quick connect fitting to a MasterFlex Luer to hose barb connector which allowed connection to the supplier Louwers Hanique tubing.

### 2.1.1 Modular Schlenk Line

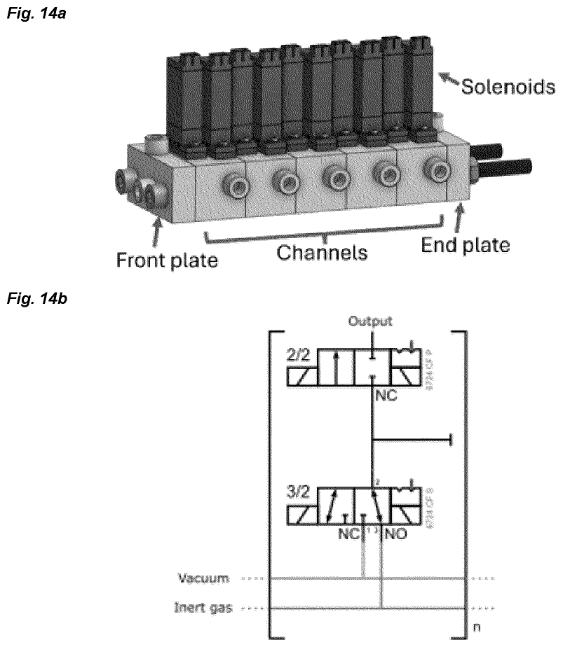

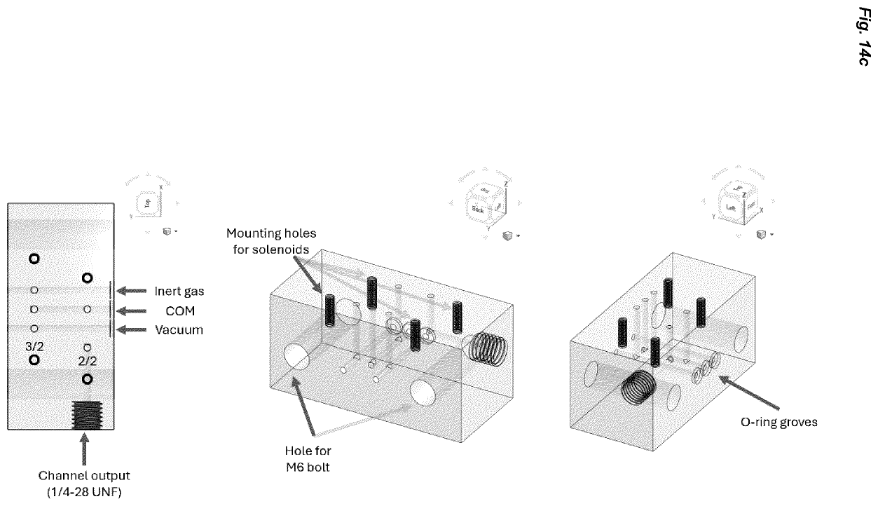

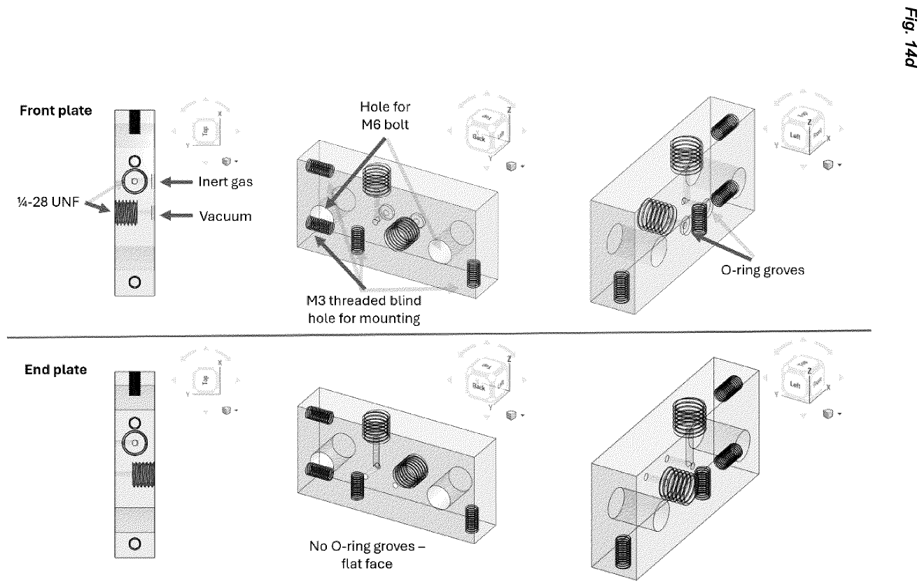

Additionally, a modular Schlenk line was prepared. A drawing of an exemplary modular Schlenk line is shown in FIG. 14a.

The Schlenk line includes separate channel modules. FIG. 14a shows five channel modules. Each module provides a single channel—corresponding to a single Louwers Hanique Tap in a traditional Schlenk. The modular Schlenk may be used as a single channel module (one channel) or multiple channel modules (multiple channels). The channel module(s) are sandwiched between a front plate and an end plate.

The modular Schlenk line is controlled by solenoid valves. Each channel module comprises a first solenoid valve and a second solenoid valve. The configuration of the solenoid valves is shown in FIG. 14b.

The first solenoid valve is a 3/2 solenoid valve. A 3/2 solenoid valve is a valve having three ports (two inlets and one outlet) and two positions. The first solenoid valve is connected to an inert gas line for one inlet and vacuum line for the other inlet. The outlet of is connected to the input of the second solenoid valve. In one position the outlet is connected to the inert gas inlet. In the other position the outlet is connected to the vacuum inlet.

The second solenoid valve is a 2/2 solenoid valve. A 2/2 solenoid valve is a valve having two ports (one inlet and one outlet) and two positions. In one position the ports are connected (open) and in the other position the ports are not connected (closed). The inlet is connected to the outlet of the first solenoid valve. The outlet is the output from the modular Schlenk line, which may be connected to the reactionware such as the glassware described below.

The modular Schlenk can provide vacuum from the vacuum line, gas from the gas line, and isolate the reactionware from the vacuum line and the gas line. These three options correspond to those provided by a Louwers Hanique Tap in a traditional Schlenk:
(1) Inert gas—when the first solenoid is open to inert gas and the second solenoid is open;
(2) Vacuum—when the first solenoid is open to vacuum and the second solenoid is open; and
(3) Isolation—when the first solenoid is open to Inert gas and the second solenoid is closed.

The solenoid valves used are Burkert 6724 solenoids. These are impulse solenoids, which only change position when power is applied. The solenoids remain in the same state in the event of power failure. This mimics a manual Schlenk-line, which maintains its state when the user is not present. This provides an added layer of safety as it avoids the possibility of pressure building up inside a reaction vessel if the solenoid closes due to de-energizing upon power failure.

The body of the solenoid is made from Polyether ether ketone (PEEK) and the seal is made from perfluoroelastomeric compounds (FFKM). These materials are designed to be in contact with chemicals and are chemically robust. The solenoids have been found to maintain pressure down to at least 2×10⁻² mbar (2 Pa). Additionally, it has been found that the flow of gas through the solenoid is largely unaffected when it has been exposed to vacuum or even solvent vapour.

The channel modules are interconnectable in series. The modules connect transversely, via their sides. The number of channels can therefore be customised. Each channel module connected in series shares the same vacuum and inert gas lines.

A drawing of the channel module is shown in FIG. 14c. The inert gas and vacuum lines pass transversely though the channel module, connecting to the inert gas and vacuum lines on adjacent modules. O-Rings are located on the side of each module, at the connection of the inert gas and vacuum lines between modules, to seal the connections. The O-rings are compressed by tightening bolts between the channel modules.

The line that connects the first and second solenoid valves (COM port) is located between the inert gas and vacuum lines, and is open to one side of the module. The open side of the COM port is closed by an adjacent module. Each module includes mounting points for the solenoid valves, and includes pneumatic connections between each solenoid.

The outlet of the channel module is perpendicular to the inert gas and vacuum lines, and is located on a longitudinal side of the module. The outlet is a ¼-28 UNF fitting (where ¼ refer to the diameter in inches (6.35 mm) and the 28 refers to threads per inch (0.907 mm pitch), which allows for the connection of tubing. The tubing then may connect to the glassware, described below.

The ¼-28 UNF fittings are standard in HPLC equipment and are fully compatible with PTFE tubing, which is chemically robust. PTFE tubing can be used in combination with flangeless fittings, which have excellent sealing properties.

The channel module(s) are sandwiched between a front plant and an end plate. The front and end plates are located at the transverse ends of the channel module(s). The front plate and end plate are shown in FIG. 14d.

The front plate and end plate provides an inlet connection for the vacuum and gas lines, and the inlets are connected to the inert gas and vacuum lines passing transversely though the channel module(s). The end plates also include pressure sensors and over-pressure relief valves connected to the vacuum and inert gas lines. The front and end plates use ¼-28 UNF fittings. The front and end plates are interchangeable. The fittings are located at the top and side of the plate to allow sufficient space for the inlet/outlets. Mounting holes are fitted to the bottom and back of the front and end plates.

The modular Schlenk line is smaller than a traditional glass Schlenk line. The 5-channel modular Schlenk line exemplified here is 130 mm long and 47 mm deep (excluding connections and bolts). A single channel modular Schlenk line is just 42 mm long. This is significantly smaller than a 5-channel Young's tap Schlenk line, which is 660 mm long (or 1,060 mm when including the cold trap).

The modular Schlenk line is controllable. The first and second solenoids in each channel modules are connected to an L293D H-bridge, which is connected to the SensorHub shield. The SensorHub shield and H-bridge are powered by Power over Ethernet (PoE)—as described below. The impulse solenoids can switch position using a pulse of polarised voltage. The SensorHub shield also provides connections for multiple sensors, for example to monitor pressure. The solenoids are controlled using Chemical Descriptive Language (XDL), using a python API.

### 2.2 Solenoid Manifold Build

For build details see the Supplementary Materials associated with Cronin et al., Nat. Chem., 2021 with key differences in the build of this manifold detailed below.

### 2.2.1 Programmable Solenoid Manifold

The differences in the build are detailed in points (1) to (4) below. A image of the build is shown in FIG. 13.
(1) Only one Rotameter (0.04-0.5 LPM air) with flow valve is required which is placed on the RHS position of the backplate.
(2) Tubing connects directly from left hand regulator to port 3 on manifold via adaptor. The right hand regulator is connected to the gas distribution manifold via an adaptor.
(3) On the right hand side the front end manifold the elbow joint is replaced with a 3 way joint. The RHS Port 1 on is replaced with a straight fitting. This allows connection of the vacuum line between the two manifolds.
(4) Outlet tubing from rotameter connects to gas line on AutoSchlenk manifold via a non-return valve.

### 2.3 Glassware Build

### 2.3.1 Isolation Flask

A 250 mL round-bottomed flask was appended with a Louwers Hanique Tap. The side arm was also appended with a screw thread joint for a GL14 adaptor and as such could either be connected to Portex tubing or directly to liquid handling depending on the intended use. The terminal O-ring on the tap was replaced with an FFKM80 O-ring (Barnwell Services, MBMS0085 4.76 mm ID, 1.78 mm thick) to avoid swelling upon solvent exposure.

### 2.3.2 Schlenk (Filter) Flask

A medium porosity filter flask was appended with two Louwers Hanique taps on either end. In turn the side arms were appended with GL14 threaded joints for connection to liquid handling system or alternatively, Portex tubing. The terminal O-rings on both taps were replaced with FFKM80 O-rings (Barnwell Services, MBMS0085 4.76 mm ID, 1.78 mm thick) to avoid swelling upon solvent exposure.

### 2.4 Other Hardware

### 2.4.1 Pneumatic Splitter

In order to connect all solvent bottles to the AutoSchlenk system at once, the gas/vacuum line was split using a Swagelock 4-way fitting appended with four hose connectors sealed with PTFE tape.

### 2.4.2 Tube-in-Tube Splitter

A 4-way manifold was appended with two brass hose connectors, a blocking plug and a thermocouple compression fitting. The hose connectors were appended with Portex tubing. 1/8″ (3.175 mm) PTFE tubing was threaded through the thermocouple compression fitting and through the Portex tubing until it was slightly longer than the outer tubing and the compression fitting was tightened.

### 2.4.3 In-Line Filters for Liquid Handling System

Where applicable these filters were used and these were associated with a specific port on a flask, where the tubing to a port was appended with a filter.

### 2.5 Benchtop NMR

The benchtop NMR was a Spinsolve 43 Carbon from Magritek:
Frequency: 43 MHz Proton
Resolution: 50% linewidth <0.5 Hz
Lineshape: 0.55% linewidth <20 Hz
¹H Sensitivity: >120:1 for 1% ethyl benzene
Dimensions: 58×43×40 cm
Weight: 60 kg
Magnet: Permanent and cryogen free
Stray field: <2 G all around system

The instrument was equipped with a flow-cell (Spinsolve SPSFC) to allow online analysis. The cell was fed through the instrument and its location places the NMR tube at the centre of the magnets. Both inlet and outlet were connected to ⅛″ PTFE tubing with IDEX screw fittings which was also connected to one of the ChemPU valves. The flow cell allowed automatic reaction monitoring in real time by pumping 9 mL of solution from the reaction mixture. In order to inertize the tubing, clean and dry solvent (10 mL) was pumped in and out of the flow cell in triplicate before an analysis was conducted.

### 2.6 Temperature Sensor Setup

### 2.6.1 SensorHub

As with the solenoid manifold above, the SensorHub system allows communication with the temperature sensors over ethernet. SensorHub consists of an Arduino fitted with a custom-design MOSFET shield with built-in Ethernet module for control over an IP. Overall, this allows installation of up to 8 analog sensors, 8 sensors with I2C communication (achieved using an I2C multiplexer, thus allowing installation of devices with same addresses), several sensors with SPI communication (achieved via “software SPI” Arduino feature) and up to 12 PWM devices.

### 2.6.2 Reaction Temperature Sensor (RTD)

The MAX31865 RTD-to-Digital Converter was selected to simplify the interfacing the SensorHub with resistance temperature detector (RTD, or temperature probe). The unit has a built-in 15-bit ADC, input protection, a digital controller, and an SPI-compatible interface. We selected the Adafruit PT100 RTD Temperature Sensor Amplifier as an evaluation board for the MAX31865 converter and 4-wire PTFE-encapsulated PT100 temperature probe (BOLA, part No. P1750-15) installed via screw fitting (BOLA, part No. D629-54 for GL18 glass thread) on the round bottom flask.

### 2.7 Ultra Low Temperature Chiller Setup

Temperature control in the synthesis platform was achieved using a HuberTC 100EF immersion cooling chiller incorporated using an RS232 to USBe adaptor. The chiller can achieve temperatures as low as −100° C. through automated control. After cooling the most efficient reheating method for reactor flasks was found to involve simple siphoning off of the cooling bath solvent, since this most closely mirrors the manual action of removing an REF from a cooling bath, warming to room temp in ca 90-120 mins. This was achieved using a partitioned pump/valve setup.

### 3 Software

### 3.1 XDL General

All Code associated with this platform and paper, including XDL files as executed, can be found at https://github.com/croningp/Inertputer and is based upon the language outlined in Mehr et al.

### 3.2XDL Steps Description

TABLE 1
XDL synthesis steps implemented in the platform.

| Step | Description |
|---|---|
| Add | Adds given volume of given reagent/solvent to given |
| | vessel |
| AddSolid | Stops run to allow solid to be added manually with user |
| | confirmation |
| Transfer | Transfers solution from one flask to another |
| StartPurge | Opens Schlenk Line Tap to place flask under a blanket of |
| | N₂ |
| EvacuateAndRefil | Sequentially opens and closes vacuum and gas line taps |
| | on AutoSchlenk line to cycle and inertise a flask/line |
| StartStir | Sets stir rate and begins stirring through hotplate |
| HeatChill | Heat/Chills given cartridge to given temperature for given |
| | time |
| WashSolid | Washes solid in given cartridge by adding solvent and |
| | filtering n times |
| CConnect | Turns the valve so that a specific flask has a direct |
| | pathway between the flask and pump. Used to evacuate |
| | liquid handling system |
| ResetHandling | Washes the liquid handling backbone with solvent. Also |
| | helps to purge air from valve connections |
| Confirm | Takes no action until the user confirms |
| PrimePumpforAdd | Aspirates 3 mL (default) of reagent into lines to ensure |
| | accurate dispensing during add steps |
| SchlenkLineTapOpenVacuum | Opens the Louwers Hanique tap on the Vacuum line of the |
| | AutoSchlenk line at the defined position |
| SchlenkLineTapOpenArgon | Opens the Louwers Hanique tap on the Inert Gas line of |
| | the AutoSchlenk line at the defined position |
| SchlenkLineTapClose | Closes both Louwers Hanique taps on the AutoSchlenk |
| | line at the defined position |
| SchlenkFlaskTapOpen | Opens the Louwers Hanique tap on the Inertputer Flask at |
| | the defined position |
| SchlenkFlaskTapClose | Closes the Louwers Hanique tap on the Inertputer Flask at |
| | the defined position. |
| Async | All commands within Async terms will run concurrently |
| | rather than in sequence |
| AddDynamic | Add reagent with reference to temperature measurements |
| | and within stated safety limits |
| RunNMR | Engages Spinsolve software to collect spectral data from |
| | Magritek Low Field NMR machine |

### 3.3 XDL Description for Preparation of [Cp₂Ti(CH₃CN)₂]₂[ZnCl₄](1)

The following is the XDL file executed by the platform in concert with the graph shown in FIG. 8. The XDL file has three sections: Hardware, Reagents and Procedure. Comments are added for clarity of the reader.

```
<Synthesis>
  <Hardware>
  <Component
    id=“Pump1”
    type=‘Pump’
  />
  <Component
    id=“Pump2”
    type=‘Pump’
  />
  <Component
    id=“Line”
    type=“pneumatic_controller”
  />
  <Component
    id=“Waste”
    type=‘waste’
  />
  <Component
    id=“PneumaticSplitter”
    type=“custom”
  />
  <Component
    id=“Schlenk Flask”
    type=“filter”
  />
  <Component
    id=“Round Bottomed Flask”
    type=“reactor”
  />
  <Component
    id=“Two Necked Flask”
    type=“reactor”
  />
  <Component
    id=“Valve 1”
    type=‘Valve’
  />
  <Component
    id=“Valve 2”
    type=‘Valve’
  />
</Hardware>
<Reagents>
  <Reagent
    name=‘Cp2TiCl2’
    type=‘solvent’
  />
  <Reagent
    name=‘Zinc Dust’
    type=‘solvent’
  />
  <Reagent
    name=‘MeCN’
    type=‘solvent’
  />
  <Reagent
    name=‘THF’
    type=‘solvent’
  />
  <Reagent
    name=‘Ether’
    type=‘solvent’
  />
  <Reagent
    name=“Oil”
    type=‘solvent’
  />
  </Reagents>
<Procedure>
  <!-- Connecting Schlenk Flask hot out of the oven and pulling vaccum -->
  <Confirm
    msg = ‘Is Schlenk Flask Connected?’
  />
  <SchlenkFlaskTapOpen
    pneumatic_controller=‘Line’
    position=‘top’
  />
  <CConnect
    from_vessel = ‘Schlenk Flask’
    to_vessel = ‘Pump1’
  /> <!--CConnect allows us to vac out the tubing up to the pump-->
  <SchlenkLineTapOpenVacuum
    pneumatic_controller=‘Line’
    port=‘1’
  />
  <!-- Connecting Round Bottomed Flask Flask hot out of the oven and pulling vaccum
  -->
  <Confirm
    msg = ‘Is Round Bottomed Flask Connected?’
  />
  <CConnect
    from_vessel = ‘Round Bottomed Flask’
    to_vessel = ‘Pump1’
  />
  <SchlenkLineTapOpenVacuum
    pneumatic_controller=‘Line’
    port=‘2’
  />
  <!-- Connecting Two Necked Flask Flask hot out of the oven and pulling vaccum -->
  <Confirm
    msg = ‘Is Two Necked Flask Connected?’
  />
  <CConnect
    from_vessel = ‘Two Necked Flask’
    to_vessel = ‘Pump2’
  />
  <SchlenkLineTapOpenVacuum
    pneumatic_controller=‘Line’
    port=‘3’
  />
  <Wait
    time = ‘5 minutes’
  /> <!-- Let the flasks cool to room temp.-->
  <!-- Starting to purge Two Necked Flask with N2, manually charging it with Cp2TiCl2,
  then pulling vacuum -->
  <StartPurge
    vessel = ‘Two Necked Flask’
  />
  <AddSolid
    vessel = ‘Two Necked Flask’
    reagent = ‘Cp2TiCl2’
    mass = ‘8.3 g’
    confirm_solid = ‘True’
  />
  <SchlenkLineTapOpenVacuum
    pneumatic_controller=‘Line’
    port=‘3’
  />
  <!-- Starting to purge Round Bottomed Flask and manually charging it with Zinc metal
  dust, then pulling vacuum -->
  <StartPurge
    vessel = ‘Round Bottomed Flask’
  />
  <AddSolid
    vessel = ‘Round Bottomed Flask’
    reagent = ‘Zinc Dust’
    mass = ‘2.3 g’
    confirm_solid = ‘True’
  />
  <SchlenkLineTapOpenVacuum
    pneumatic_controller=‘Line’
    port=‘2’
  />
  <! - Alternately pulling vacuum and purging on the three flasks, three times. The
  Async command allows all of these flasks to be evacuated and refilled at the same
  time-->
  <Async><!-- this splits the gas line to connect to all three solvent flasks -->
    <EvacuateAndRefill
      vessel=‘PneumaticSplitter’
      after_vacuum_wait_time=‘3 minutes’
      repeats=‘3’
      gas=‘low’
    />
  </Async>
  <Async>
    <EvacuateAndRefill
      vessel=‘Two Necked Flask’
      after_vacuum_wait_time=‘3 minutes’
      repeats=‘3’
      gas=‘low’
    />
  </Async>
  <Async>
    <Wait
      time = ‘5 seconds’
    />
    <EvacuateAndRefill
      vessel=‘Round Bottomed Flask’
      after_vacuum_wait_time=‘3 minutes’
      repeats=‘3’
      gas=‘high’
    />
  </Async>
  <Async>
    <Wait
      time = ‘10 seconds'
    />
    <EvacuateAndRefill
      vessel=‘Schlenk Flask’
      after_vacuum_wait_time=‘3 minutes’
      repeats=‘3’
      gas=‘high’
    />
  </Async>
  <Wait
    time = ‘13 mins’
  />
  <!—Putting all three flasks under N2 to begin the reaction -->
  <StartPurge
    vessel = ‘Schlenk Flask’
  />
  <StartPurge
    vessel = ‘Round Bottomed Flask’
  />
  <StartPurge
    vessel = ‘Two Necked Flask’
  />
  <!—Putting the solvents under N2 and manually connecting tubing to solvent -->
  <StartPurge
    vessel = ‘PneumaticSplitter’
  />
  <Confirm
    msg = ‘Are the three solvents connected?’
  />
  <!-- Priming and clearing the backbone of air before solvent addition-->
  <ResetHandling
    solvent=‘THF’
    repeats=‘3’
    volume=‘5mL’
  />
  <!-- Step 1: Add Solvents & Stir-->
  <Add
    reagent=‘THF’
    vessel=‘Two Necked Flask’
    volume = ‘75 mL’
  />
  <ResetHandling
    solvent=‘MeCN’
    repeats=‘3’
    volume=‘5mL’
  />
  <Add
    reagent=‘MeCN’
    vessel=‘Two Necked Flask’
    volume = ‘25 mL’
  />
  <Stir
    vessel=‘Two Necked Flask’
    time= ‘40 mins’
    stir_speed = ‘200’
  />
  <!-- Add solution of Cp2TiCl2 to Flask containing Zn Dust-->
  <StartStir
    vessel=‘Round Bottomed Flask’
    stir_speed = ‘200’
  />
  <Transfer
    from_vessel=‘Two Necked Flask’
    to_vessel=‘Round Bottomed Flask’
    volume = ‘100 mL’
    rinsing_solvent = ‘MeCN’
    rinsing_volume = ‘5 mL’
    rinsing_repeats = ‘2’
    aspiration_speed = ‘100’
    move_speed = ‘50’
    dispense_speed = ‘200’
  />
  <StopStir
    vessel = ‘Two Necked Flask’
  />
  <!-- Reduction through Zn metal dust takes place over 30 minutes, while solution
changes colour -->
  <Wait
    time = ‘30 mins’
  />
  <!-- Opening bottom tap of Schlenk Flask and addition of Diethyl Ether from the
bottom -->
  <SchlenkFlaskTapOpen
    pneumatic_controller=‘Line’
    position=‘bottom’
  />
  <AddFilterDeadVolume
    filter_vessel = ‘Schlenk Flask’
    solvent = ‘Ether’
    volume = ‘20 mL’
  />
  <SchlenkFlaskTapClose
    pneumatic_controller=‘Line’
    position=‘bottom’
  />
  <!--Transfering reaction mixture from Round Bottomed Flask through filter into
Schlenk Flask-->
  <SchlenkFlaskTapOpen
    pneumatic_controller=‘Line’
    position=‘top’
  />
  <Transfer
    from_vessel=‘Round Bottomed Flask’
    to_vessel=‘Schlenk Flask’
    to_port=‘top’
    volume = ‘130 mL’
  />
  <!-- Layering of diethyl ether ontop of solution and waiting 48h for crystallisation to
occur -->
  <Add
    reagent=‘Ether’
    vessel=‘Schlenk Flask’
    volume = ‘150 mL’
  />
  <Wait
    time = ‘72 h’
  />
  <!- Removing liquid from the bottom of Schlenk Flask with filter, leaving solid product
in Schlenk Flask-->
  <SchlenkFlaskTapOpen
    pneumatic_controller=‘Line’
    position=‘bottom’
  />
  <Transfer
    from_vessel=‘Schlenk Flask’
    from_port=‘bottom’
    to_vessel=‘Waste’
    volume = ‘350 mL’
  />
  <SchlenkFlaskTapClose
    pneumatic_controller=‘Line’
    position=‘bottom’
  />
  <!-- Addition of Oil prepares and protects obtained blue crystals for x-ray
crystallography, closing of taps at Schlenk Flask stores product under nitrogen, to transport it
conveniently to x-ray machine -->
  <SchlenkFlaskTapOpen
    pneumatic_controller=‘Line’
    position=‘top’
  />
  <Add
    reagent=‘Oil’
    vessel=‘Schlenk Flask’
    port=‘top’
    volume=‘20 mL’
  />
  <SchlenkFlaskTapClose
    pneumatic_controller=‘Line’
    position=‘top’
/>
</Procedure>
</Synthesis>
```

### 3.4 XDL Description for Preparation of Ce(N(SiMe₃)₂)₃ (2)

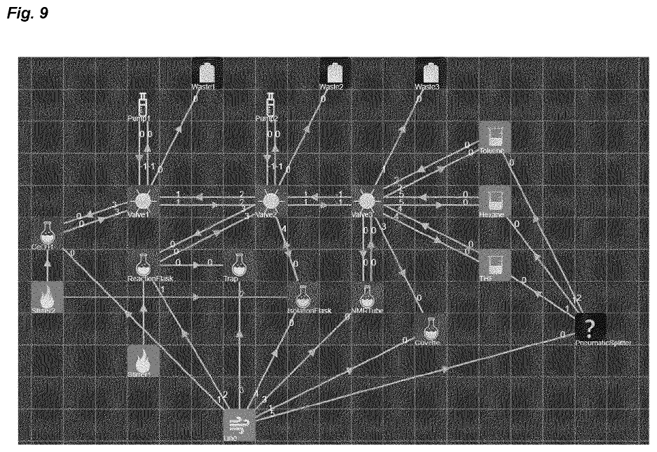

The following is the XDL file executed by the platform in concert with the graph shown in FIG. 9. The XDL file has three sections: Hardware, Reagents and Procedure. Comments are added for clarity of the reader.

```
<Synthesis>
  <Hardware>
  <Component
    id=“PneumaticSplitter”
    type=“custom”
  />
  <Component
    id=“Trap”
    type=“reactor”
  />
  <Component
    id=“ReactionFlask”
    type=“reactor”
  />
  <Component
    id=“IsolationFlask”
    type=“reactor”
  />
  <Component
    id=“CeOTf”
    type=“reactor”
  />
  <Component
    id=“Cuvette”
    type=“reactor”
  />
  <Component
    id=“NMRTube”
    type=“reactor”
  />
  <Component
    id=“Line”
    type=“pneumatic_controller”
  />
  <Component
    id=“Valve1”
    type=‘Valve’
  />
  <Component
    id=“Valve2”
    type=‘Valve’
  />
  <Component
    id=“Valve3”
    type=‘Valve’
  />
  <Component
    id=“Pump1”
    type=‘Pump’
  />
  <Component
    id=“Pump2”
    type=‘Pump’
  />
  <Component
    id=“Waste3”
    type=‘Waste’
  />
  <Component
    id=“Waste1”
    type=‘Waste’
  />
  <Component
    id=“Waste2”
    type=‘Waste’
  />
</Hardware>
<Reagents>
  <Reagent
    name=‘Toluene’
    type=‘solvent’
  />
  <Reagent
    name=‘Hexane’
    type=‘solvent’
  />
  <Reagent
    name=‘THF’
    type=‘reagent’
  />
  <Reagent
    name=‘CeOTf3’
    type=‘solid’
  />
  <Reagent
    name=‘KN’
    type=‘solid’
  />
</Reagents>
<Procedure> -
  <!--Reaction Setup -->
  <!--Connect Reaction Flasks-->
  <Confirm
    msg = ‘Is CeOTf Connected?’
  />
  <SchlenkLineTapOpenVacuum
    pneumatic_controller=‘Line’
    port=‘1’
  />
  <CConnect
    from_vessel = ‘CeOTf’
    to_vessel = ‘Pump1’
  />
  <Confirm
    msg = ‘Is ReactionFlask Connected?’
  />
  <SchlenkLineTapOpenVacuum
    pneumatic_controller=‘Line’
    port=‘2’
  />
  <CConnect
    from_vessel = ‘ReactionFlask’
    to_vessel = ‘Pump2’
  />
  <Wait
    time = ‘2 min’
  />
  <Confirm
    msg = ‘Are flasks cool to rt?’
  />
  <!-- EvacuateAndRefill Steps for Flasks-->
  <Async>
  <EvacuateAndRefill
    vessel=‘CeOTf’
    after_vacuum_wait_time=‘3 minutes’
    after_inert_gas_wait_time = ‘2 mins’
    repeats=‘3’
    gas=‘high’
  />
  </Async>
  <Async>
  <EvacuateAndRefill
    vessel=‘ReactionFlask’
    after_vacuum_wait_time=‘3 minutes’
    after_inert_gas_wait_time = ‘2 mins’
    repeats=‘3’
    gas=‘high’
  />
  </Async>
  <Async>
  <EvacuateAndRefill
    vessel=‘PneumaticSplitter’
    after_vacuum_wait_time=‘3 minutes’
    after_inert_gas_wait_time = ‘2 mins’
    repeats=‘3’
    gas=‘high’
  />
  </Async>
  <Wait
    time = ‘16 mins’
  />
  <Confirm
  msg = ‘Are the solvents connected to the liquid handling backbone?’
  />
  <ResetHandling
    solvent=‘THF’
    repeats=‘4’
    volume=‘5mL’
  />
  <!-- Step 1 - Begin Reaction -->
  <Add
    reagent=‘THF’
    vessel=‘CeOTf’
    volume = ‘10 mL’
    stir = ‘true’
    stir_speed = ‘500’
    aspiration_speed = ‘5’
  />
  <Stir
    vessel = ‘CeOTf’
    stir_speed = ‘500’
    time = ‘2h’
  />
  <Transfer
    from_vessel=‘CeOTf’
    to_vessel=‘ReactionFlask’
    aspiration_speed = ‘5’
    volume = ‘20 mL’
    rinsing_solvent = ‘THF’
    rinsing_volume = ‘10 mL’
    rinsing_repeats = ‘1’
  />
  <!--Step 3 -->
  <Confirm
    msg = ‘Is the cryo trap filled with liquid N2?’
  />
  <StartStir
    vessel = ‘ReactionFlask’
    stir_speed = ‘500’
  />
  <SchlenkLineTapClose
    pneumatic_controller = ‘Line’
    port = ‘2’
  />
  <SchlenkLineTapOpenVacuum
    pneumatic_controller = ‘Line’
    port = ‘3’
  />
  <SchlenkFlaskTapOpen
    pneumatic_controller = ‘Line’
    position = ‘bottom’
  />
  <Wait
  time = ‘30 mins’
  />
  <SchlenkFlaskTapClose
    pneumatic_controller = ‘Line’
    position = ‘bottom’
  />
  <SchlenkLineTapClose
    pneumatic_controller = ‘Line’
    port = ‘3’
  />
  <SchlenkLineTapOpenArgon
    pneumatic_controller = ‘Line’
    port = ‘2’
  />
  <!--Insert Analytical Sampling steps here if required (see below) -->
  <SchlenkLineTapOpenVacuum
    pneumatic_controller = ‘Line’
    port = ‘2’
  />
  <!--Evacuate flask directly overnight -->
  <SchlenkLineTapOpenVacuum
    pneumatic_controller = ‘Line’
    port = ‘2’
  />
  <Wait
    time = ‘16 h’
  />
    <SchlenkLineTapOpenArgon
    pneumatic_controller = ‘Line’
    port = ‘2’
  />
  <!--Day 2: Setup Isolation Flask and reinertise the system for
completeness/robustness-->
  <Confirm
    msg = ‘Is IsolationFlask Connected?’
  />
  <SchlenkFlaskTapOpen
    pneumatic_controller = ‘Line’
    position = ‘top’
  />
  <SchlenkLineTapOpenVacuum
    pneumatic_controller=‘Line’
    port=‘4’
  />
  <CConnect
    from_vessel = ‘IsolationFlask’
    to_vessel = ‘Pump2’
  />
  <Wait
    time = ‘2 min’
  />
  <Confirm
    msg = ‘Is IsolationFlask cool to rt?’
  />
  <SchlenkFlaskTapOpen
    pneumatic_controller = ‘Line’
    position = ‘top’
  />
  <Async>
  <EvacuateAndRefill
    vessel=‘PneumaticSplitter’
    after_vacuum_wait_time=‘3 minutes’
    after_inert_gas_wait_time = ‘2 mins’
  repeats=‘3’
  gas=‘high’
  />
  </Async>
  <Async>
  <EvacuateAndRefill
    vessel=‘IsolationFlask’
    after_vacuum_wait_time=‘3 minutes’
    after_inert_gas_wait_time = ‘2 mins’
    repeats=‘3’
    gas=‘high’
  />
  </Async>
  <Wait
    time = ‘16 mins’
  />
  <Confirm
  msg = ‘Are the solvents connected to the liquid handling backbone?’
  />
  <ResetHandling
    solvent=‘Hexane’
    repeats=‘3’
    volume=‘5mL’
  />
  <!-Step 4: Hexane extraction -->
  <Add
    reagent=‘Hexane’
    vessel=‘ReactionFlask’
    volume = ‘20 mL’
    stir = ‘true’
    stir_speed = ‘300’
  />
  <Stir
    stir_speed = ‘300’
    vessel=‘ReactionFlask’
    time = ‘10 min’
  />
  <Transfer
    from_vessel=‘ReactionFlask’
    to_vessel=‘IsolationFlask’
    aspiration_speed = ‘10’
  volume = ‘60 mL’
  />
  <StartStir
    stir_speed = ‘1000’
    vessel=‘IsolationFlask’
  />
  <Wait
    time = ‘1 min’
  />
  <SchlenkLineTapOpenVacuum
    pneumatic_controller=‘Line’
    port = ‘4’
  />
  <SchlenkFlaskTapClose
    pneumatic_controller = ‘Line’
    position = ‘top’
  />
  </Procedure>
</Synthesis>
```

Components of the XDL file below can be added to the above XDL (CeN″3 synthesis) where indicated above (i.e. before Day 2: Isolation steps) for integrated synthesis and analysis. The following XDL was run as a stand alone method for our testing.

```
<Synthesis>
  <Hardware>
  <Component
    id=“PneumaticSplitter”
    type=“reactor”
  />
  <Component
    id=“ReactionFlask”
    type=“reactor”
  />
  <Component
    id=“Cuvette”
    type=“reactor”
  />
  <Component
    id=“NMRTube”
    type=“reactor”
  />
  <Component
    id=“Line”
    type=“pneumatic_controller”
  />
  <Component
    id=“Valve1”
    type=‘Valve’
  />
  <Component
    id=“Valve2”
    type=‘Valve’
  />
  <Component
    id=“Valve3”
    type=‘Valve’
  />
  <Component
    id=“Pump1”
    type=‘Pump’
  />
  <Component
    id=“Pump2”
  type=‘Pump’
  />
  <Component
    id=“Waste3”
    type=‘Waste’
  />
  <Component
    id=“Waste1”
    type=‘Waste’
  />
  <Component
    id=“Waste2”
    type=‘Waste’
  />
  </Hardware>
<Reagents>
  <Reagent
    name=‘Toluene’
    type=‘solvent’
  />
  <Reagent
    name=‘Hexane’
    type=‘solvent’
  />
  <Reagent
    name=‘THF’
    type=‘reagent’
  />
</Reagents>
<Procedure>
  <!--Analytical Sampling Steps-->
  <Confirm
    msg = ‘Is Cuvette connected?’
  />
  <!-- Evacuating air from cuvette tubing (path
  Cuvette-Valve3-Valve2-Pump2) -->
  <CValveMoveToPosition
    valve_name = ‘Valve3’
    position = ‘3’
  />
  <SchlenkLineTapOpenVacuum
    pneumatic_controller = ‘Line’
    port = ‘1’
  />
  <Confirm
    msg = ‘Is JY NMR Tube connected?’
  />
  <SchlenkLineTapOpenVacuum
    pneumatic_controller = ‘Line’
    port = ‘3’
  />
  <Wait
    time = ‘2 mins’
  />
  <Confirm
    msg = ‘Is ReactionFlask connected?’
  />
  <CConnect
    from_vessel = ‘ReactionFlask’
    to_vessel = ‘Pump2’
  />
  <!-- Evacuate-refill solvent splitter, ReactionFlask and Cuvette -->
  <Async>
  <EvacuateAndRefill
    vessel=‘PneumaticSplitter’
    after_vacuum_wait_time=‘2 minutes’
    after_inert_gas_wait_time = ‘2 mins’
    repeats=‘3’
    gas=‘high’
    />
  </Async>
  <Async>
  <EvacuateAndRefill
    vessel = ‘ReactionFlask’
    after_vacuum_wait_time=‘2 minutes’
    after_inert_gas_wait_time = ‘2 mins’
    repeats=‘3’
      gas=‘high’
  />
  </Async>
  <Async>
  <EvacuateAndRefill
    vessel = ‘Cuvette’
    after_vacuum_wait_time=‘2 minutes’
    after_inert_gas_wait_time = ‘2 mins’
    repeats=‘3’
    gas=‘high’
  />
  </Async>
  <Async>
  <EvacuateAndRefill
    vessel = ‘NMRTube’
    after_vacuum_wait_time=‘2 minutes’
    after_inert_gas_wait_time = ‘2 mins’
    repeats=‘3’
    gas=‘high’
  />
  </Async>
  <Wait
    time = ‘15 mins’
  />
  <Confirm
    msg = ‘Are ReactionFlask and Solvents connected to liquid
    backbone?’
  />
  <ResetHandling
    solvent=‘Toluene’
    repeats=‘3’
    volume=‘5mL’
  />
  <Add
    reagent=‘Toluene’
    vessel=‘ReactionFlask’
    volume = ‘15 mL’
    stir = ‘true’
    stir_speed = ‘900’
    aspiration_speed = ‘5’
  />
  <StartStir
    stir_speed = ‘400’
    vessel=‘ReactionFlask’
  />
  <Wait
    time = ‘10 mins’
  />
  <!--Transfer UV/vis/NIR/Luminesence sample to cuvette and seal up-->
  <Transfer
    from_vessel=‘ReactionFlask’
    to_vessel=‘Cuvette’
    aspiration_speed = ‘5’
    volume = ‘5 mL’
  />
  <SchlenkLineTapOpenVacuum
    pneumatic_controller = ‘Line’
    port = ‘3’
  />
  <!--Transfer NMR sample to J-Youngs tapped NMR tube and seal up-->
  <Confirm
    msg = ‘Is NMR tube sealed under vacuum?’
  />
  <Transfer
    from_vessel=‘ReactionFlask’
    to_vessel=‘NMRTube’
    aspiration_speed = ‘5’
    volume = ‘3 mL’
  />
  <Confirm
    msg = ‘Is NMR tube opened to pull through solution?’
  />
  <SchlenkLineTapOpenArgon
    pneumatic_controller = ‘Line’
    port = ‘3’
  />
  <Confirm
    msg = ‘Are cuvette, NMR tube and solvents sealed?’
  />
  <SchlenkLineTapClose
    pneumatic_controller=‘Line’
    port = ‘1’
  />
  <SchlenkLineTapClose
    pneumatic_controller=‘Line’
    port = ‘3’
  />
  </Procedure>
</Synthesis>
```

### 3.5 XDL Description for Preparation of CeOTf₃

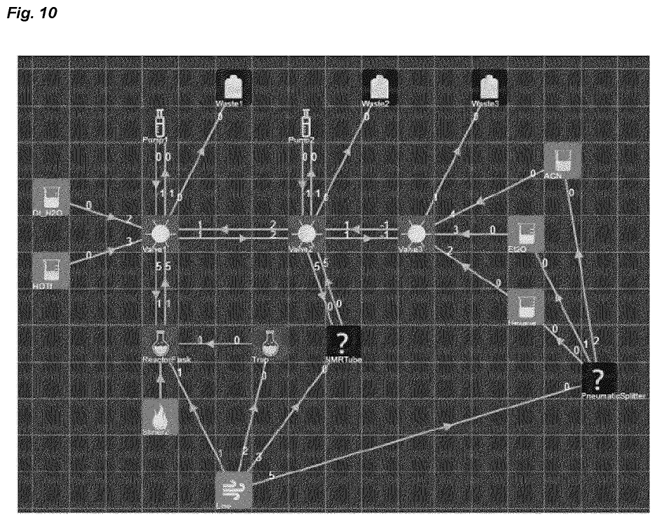

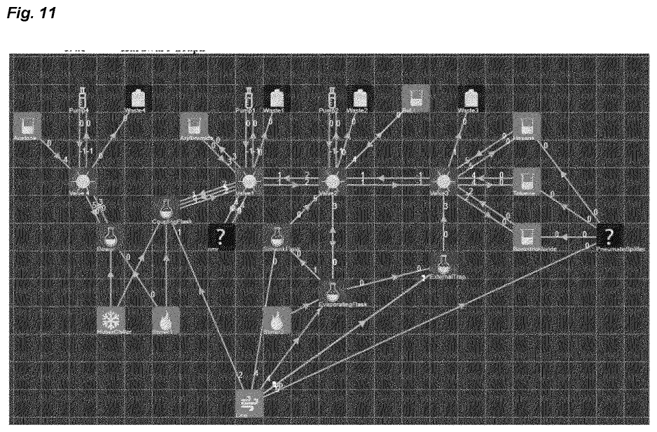

The following is the XDL file executed by the platform in concert with the graph shown in FIG. 10. The XDL file has three sections: Hardware, Reagents and Procedure. Comments are added for clarity of the reader.

```
<Synthesis>
<Hardware>
  <Component
    id=“PneumaticSplitter”
    type=“reactor”
  />
  <Component
    id=“Trap”
    type=“reactor”
  />
  <Component
    id=“ReactorFlask”
    type=“reactor”
  />
  <Component
    id=“NMRTube”
    type=“reactor”
  />
  <Component
    id=“HOTf”
    type=“Flask”
  />
  <Component
    id=“DI_H2O”
    type=“Flask”
  />
  <Component
    id=“Et2O”
    type=“Flask”
  />
  <Component
    id=“ACN”
    type=“Flask”
  />
  <Component
    id=“Hexane”
    type=“Flask”
  />
  <Component
    id=“Line”
    type=“pneumatic_controller”
  />
  <Component
    id=“Valve1”
    type=‘Valve’
  />
  <Component
    id=“Valve2”
    type=‘Valve’
  />
  <Component
    id=“Valve3”
    type=‘Valve’
  />
  <Component
    id=“Pump1”
    type=‘Pump’
  />
  <Component
    id=“Pump2”
    type=‘Pump’
  />
  <Component
    id=“Waste3”
    type=‘Waste’
  />
  <Component
    id=“Waste1”
    type=‘Waste’
  />
  <Component
    id=“Waste2”
    type=‘Waste’
  />
  </Hardware>
<Reagents>
  <Reagent
    name=‘Et2O’
    type=‘solvent’
  />
  <Reagent
    name=‘Hexane’
    type=‘solvent’
  />
  <Reagent
    name=‘ACN’
    type=‘solvent’
  />
  <Reagent
    name=‘DI_H2O’
    type=‘solvent’
  />
  <Reagent
    name=‘HOTf’
    type=‘solution’
  />
  <Reagent
    name=‘Ce2CO33’
    type=‘solid’
  />
</Reagents>
<Procedure> -
  <!-- Setup Flasks & Solvents -->
  <Confirm
    msg = ‘Is Ce2(CO3)3 (1.5 g) loaded into ReactorFlask?’
  />
  <CConnect
    from_vessel = ‘ReactorFlask’
    to_vessel = ‘Pump1’
  />
  <SchlenkLineTapOpenVacuum
    pneumatic_controller = ‘Line’
    port = ‘1’
  />
  <Wait
    time = ‘2 mins’
  />
  <!-- EvacuateAndRefill Steps for ReactorFlask and Trap-->
  <Async>
  <EvacuateAndRefill
    vessel=‘ReactorFlask’
    after_vacuum_wait_time=‘2 min’
    after_inert_gas_wait_time = ‘3 min’
    repeats=‘3’
    gas=‘high’
  />
  </Async>
  <Async>
  <EvacuateAndRefill
    vessel=‘PneumaticSplitter’
    after_vacuum_wait_time=‘2 min’
    after_inert_gas_wait_time = ‘3 min’
    repeats=‘3’
    gas=‘high’
  />
  </Async>
  <Wait
    time = ‘16 mins’
  />
  <!-- Begin Reaction -->
  <SchlenkLineTapOpenArgon
    pneumatic_controller = ‘Line’
    port = ‘1’
  />
  <StartStir
    vessel = ‘ReactorFlask’
    stir_speed = ‘500’
  />
  <Transfer
    from_vessel=‘DI_H2O’
    to_vessel=‘ReactorFlask’
    aspiration_speed = ‘15’
    volume = ‘20 mL’
    from_port = ‘0’
    to_port = ‘1’
  />
  <Wait
    time = ‘1 min’
  />
  <Confirm
    msg = ‘Is HOTf connected to the liquid backbone?’
  />
  <Transfer
    from_vessel=‘HOTf’
    to_vessel=‘ReactorFlask’
    aspiration_speed = ‘1’
    volume = ‘2 mL’
    to_port = ‘1’
    dispense_speed = ‘1’
  />
  <HeatChillToTemp
    vessel = ‘ReactorFlask’
    temp = ‘100’
    active = ‘True’
    continue_heatchill = ‘True’
    stir = ‘True’
    stir_speed = ‘500’
  />
  <Wait
    time = ‘18 h’
  />
  <HeatChillReturnToRT
    vessel = ‘ReactorFlask’
    stir = ‘True’
    stir_speed = ‘250’
  />
  <!-- Day 2. Evaporation -->
  <Confirm
    msg= ‘Is external trap filled with liquid N2?’
  />
  <StartStir
    vessel = ‘ReactorFlask’
    stir_speed = ‘500’
  />
  <SchlenkLineTapClose
    pneumatic_controller = ‘Line’
    port = ‘1’
  />
  <SchlenkLineTapOpenVacuum
    pneumatic_controller = ‘Line’
    port = ‘2’
  />
    <SchlenkFlaskTapOpen
    pneumatic_controller = ‘Line’
    position = ‘top’
  />
  <Wait
    time = ‘1h’
  />
  <SchlenkFlaskTapClose
    pneumatic_controller = ‘Line’
    position = ‘top’
  />
  <SchlenkLineTapClose
    pneumatic_controller = ‘Line’
    port = ‘2’
  />
  <!-- Wash solids -->
  <SchlenkLineTapOpenArgon
    pneumatic_controller = ‘Line’
    port = ‘1’
  />
  <EvacuateAndRefill
    vessel=‘PneumaticSplitter’
    after_vacuum_wait_time=‘3 minutes’
    after_inert_gas_wait_time = ‘1 mins’
    repeats=‘3’
    gas=‘high’
  />
  <Confirm
    msg = ‘Are the solvents connected to the LH backbone’
  />
  <ResetHandling
    solvent = ‘Et2O’
    volume = ‘10 ml’
    repeats = ‘2’
  />
  <WashSolid
    vessel= ‘ReactorFlask’
    solvent = ‘Et2O’
    aspiration_speed = ‘10’
    volume = ‘10 mL’
    stir = ‘True’
    stir_speed = ‘500’
    time =‘ 5 min’
    vacuum_attached = ‘False’
    repeats = ‘4’
  />
  <!-- Wash two times with hexanes -->
  <ResetHandling
    solvent = ‘Hexane’
    volume = ‘3mL’
    repeats = ‘3’
  />
  <WashSolid
    vessel= ‘ReactorFlask’
    solvent = ‘Hexane’
    aspiration_speed = ‘10’
    volume = ‘10 mL’
    stir = ‘True’
    stir_speed = ‘500’
    time =‘ 5 min’
    vacuum_attached = ‘False’
    repeats = ‘2’
  />
  <SchlenkLineTapOpenVacuum
    pneumatic_controller = ‘Line’
    port = ‘1’
  />
  <HeatChill
    vessel = ‘ReactorFlask’
    temp = ‘220’
    time = ‘36 h’
    stir = ‘True’
    stir_speed = ‘400’
  />
  <HeatChillReturnToRT
    vessel = ‘ReactorFlask’
    stir = ‘True’
    stir_speed = ‘250’
  /> -->
  <!-- Prep NMR sample -->
  <ResetHandling
    solvent = ‘ACN’
    volume = ‘3 mL’
    repeats = ‘3’
  />
  <Transfer
    to_vessel = ‘ReactorFlask’
    to_port = ‘1’
    from_vessel = ‘ACN’
    from_port = ‘0’
    volume = ‘30 mL’
  />
  <StartStir
    vessel = ‘ReactorFlask’
    stir_speed = ‘500’
  />
  <Wait
    time = ‘10 min’
  />
  <!-- Take NMR sample -->
<Confirm
    msg = ‘NMR tube connected?’
  />
  <CConnect
    from_vessel = ‘ReactorFlask’
    to_vessel = ‘Pump2’
  />
  <EvacuateAndRefill
    vessel=‘NMRTube’
    after_vacuum_wait_time=‘3 minutes’
    after_inert_gas_wait_time = ‘1 mins’
    repeats=‘3’
    gas=‘high’
  />
  <SchlenkLineTapOpenVacuum
    pneumatic_controller = ‘Line’
    port = ‘3’
  />
  <Confirm
    msg = ‘Is NMR tube closed under vacuum?’
  />
  <SchlenkLineTapOpenArgon
    pneumatic_controller = ‘Line’
    port = ‘3’
  />
  <Transfer
    from_vessel = ‘ReactorFlask’
    from_port = ‘1’
    to_vessel = ‘Waste1’
    to_port = ‘0’
    volume = ‘2 mL’
    aspiration_speed = ‘2’
  />
  <StartStir
    vessel = ‘ReactorFlask’
    stir_speed = ‘400’
  />
  <Transfer
    from_vessel = ‘ReactorFlask’
    from_port = ‘1’
    to_vessel = ‘NMRTube’
    to_port = ‘0’
    volume = ‘2 mL’
    aspiration_speed = ‘2’
  />
  <Confirm
    msg = ‘Is NMR tube filled?’
  /> -->
  </Procedure>
</Synthesis>
```

### 3.6 XDL Description for Preparation of B(C₆F₅)₃ (3)

The following is the XDL file executed by the platform in concert with the graph shown in FIG. 11. The XDL file has three sections: Hardware, Reagents and Procedure. Comments are added for clarity of the reader.

```
<Synthesis>
  <Hardware>
  <Component
    id=“CouplingFlask”
    type=“reactor”
  />
  <Component
    id=“PneumaticSplitter”
    type=“custom”
  />
  <Component
    id=“Toluene”
    type=“reagent”
  />
  <Component
    id=“EvaporatingFlask”
    type=“reactor”
  />
  <Component
    id=“ExternalTrap”
    type=‘reactor’
  />
  <Component
    id=“SchlenkFlask”
    type=“reactor”
  />
  <Component
    id=“nmr”
    type=“custom”
  />
  <Component
    id=“Line”
    type=“pneumatic_controller”
  />
  <Component
    id=“HuberChiller”
  type=“chiller”
  />
  <Component
    id=“Dewar”
    type=‘reactor’
  />
  <Component
    id=“Valve1”
    type=‘Valve’
  />
  <Component
    id=“Valve2”
    type=‘Valve’
  />
  <Component
    id=“Valve3”
    type=‘Valve’
  />
  <Component
    id=“Valve4”
    type=‘Valve’
  />
  <Component
    id=“Pump1”
    type=‘Pump
  >
  <Component
    id=“Pump2”
    type=‘Pump’
  />
  <Component
    id=“Pump3”
    type=‘Pump’
  />
  <Component
    id=“Waste3”
    type=‘Waste’
  />
  <Component
    id=“Waste4”
    type=‘Waste’
  />
  <Component
    id=“Waste1”
    type=‘Waste’
  />
  <Component
    id=“Waste2”
    type=‘Waste’
  />
  </Hardware>
  <Reagents>
  <Reagent
    name=‘Hexane’
    type=‘solvent’
  />
  <Reagent
    name=‘Acetone’
    type=‘solvent’
  />
  <Reagent
    name=‘Toluene’
    type=‘solvent’
  />
  <Reagent
    name=‘Arylbromide’
    type=‘reagent’
  />
  <Reagent
    name=‘Borontrichloride’
    type=‘reagent’
  />
  <Reagent
    name=‘BuLi’
    type=‘reagent’
  />
</Reagents>
<Procedure>
  <!-- Setup Flasks & Solvents -->
  <Confirm
    msg = ‘Is CouplingFlask Connected?’
  />
    <SchlenkLineTapOpenVacuum
    pneumatic_controller=‘Line’
    port=‘2’
  />
  <CConnect
    from_vessel = ‘CouplingFlask’
    to_vessel = ‘Pump1’
  />
  <Confirm
    msg = ‘Is EvaporatingFlask Connected?’
```

/><!—When setting up open tap on inverted Schlenk flask so that tubing up to the line is also evacuated. Make sure N2 does not slightly pop the tap out during the run. This is where elastic bands are best. →

```
<SchlenkLineTapOpenVacuum
  pneumatic_controller=‘Line’
  port=‘4’
/>
<CConnect
  from_vessel = ‘EvaporatingFlask’
  to_vessel = ‘Pump2’
/> -->
<Wait
  time = ‘2 min’
/>
<Async>
<EvacuateAndRefill
  vessel=‘CouplingFlask’
  after_vacuum_wait_time=‘3 minutes’
  repeats=‘3’
  gas=‘high’
/>
</Async>
<Async>
<EvacuateAndRefill
  vessel=‘EvaporatingFlask’
  after_vacuum_wait_time=‘3 minutes’
  repeats=‘3’
  gas=‘high’
/>
</Async>
<Async>
<EvacuateAndRefill
  vessel = ‘PneumaticSplitter’
  after_vacuum_wait_time=‘3 minutes’
  repeats=‘3’
  gas=‘high’
/>
</Async>
<Wait
  time = ‘13 mins’
/>
```

<!−—This steps allows us to replace the rotoflow tap on the solvent ampoule with a SubaSeal and Liquid Handling Tubing→

```
  <Confirm
    msg = ‘Are the solvents connected to the liquid handling backbone?’
  />
  <ResetHandling
    solvent=‘Toluene’
    repeats=‘3’
    volume=‘5mL’
  />
  <!-- Begin Reaction -->
  <Add
    reagent=‘Toluene’
    vessel=‘CouplingFlask’
    port = ‘0’
    volume = ‘13 mL’
    stir = ‘true’
    stir_speed = ‘200’
  />
  <Add
    reagent=‘Arylbromide’
    vessel=‘CouplingFlask’
    volume=‘1.6 mL’
    dispense_speed=‘20’
    stir = ‘true’
    stir_speed=‘200’
    port = ‘0’
  />
  <Add
    reagent=‘Toluene’
    vessel=‘CouplingFlask’
    port = ‘0’
    volume = ‘5 mL’
    dispense_speed=‘20’
    stir = ‘true’
    stir_speed=‘200’
  />
  <HeatChillToTemp
    vessel = ‘CouplingFlask’
    temp = ‘−80’
    active = ‘True’
    continue_heatchill = ‘True’
  />
  <StartStir
    vessel = ‘CouplingFlask’
    stir_speed = ‘400’
  />
  <Add
    reagent=‘BuLi’
    vessel=‘CouplingFlask’
    volume = ‘7.8 mL’
    port = ‘0’
    dispense_speed=‘1’
    stir_speed = ‘200’
    stir = ‘true’
  />
  <Add
    reagent=‘Toluene’
    vessel=‘CouplingFlask’
    port = ‘0’
    volume = ‘5 mL’
    dispense_speed=‘1’
    stir_speed = ‘200’
    stir = ‘true’
  />
  <Wait
    time = ‘1h’
  />
  <!-- Slow Addition at −80 °C -->
  <Confirm
    msg = ‘BCl3 connected to SchlenkLine?’
  />
  <Add
    reagent=‘Borontrichloride’
    vessel=‘CouplingFlask’
    volume = ‘4.2 mL’
    port = ‘0’
    aspiration_speed = ‘1’
    dispense_speed=‘5’
    stir_speed = ‘200’
  />
  <Add
    reagent=‘Toluene’
    vessel=‘CouplingFlask’
    port = ‘0’
    volume = ‘5 mL’
    dispense_speed=‘5’
    stir_speed = ‘200’
  />
  <Wait
    time = ‘60 min’
  />
  <!--Warm flask to RT by siphoning off cold bath-->
  <Async>
  <Transfer
    from_vessel = ‘Dewar’
    to_vessel = ‘Waste4’
    volume = ‘2000’
    aspiration_speed = ‘100’
    dispense_speed = ‘100’
  />
  </Async>
  <HeatChillToTemp
    vessel = ‘CouplingFlask’
    temp = ‘10’
    active = ‘True’
    continue_heatchill = ‘True’
  /> -->
  <Add
    vessel = ‘Dewar’
    reagent = ‘Acetone’
    volume = ‘500’
  />
  <!--Cleaning Benchtop NMR-->
  <CleanVessel
    vessel = ‘nmr’
    solvent = ‘Toluene’
    volume = ‘10 mL’
    repeats = ‘3’
  />
  <!-- First NMR measurement-->
  <Transfer
    from_vessel = ‘CouplingFlask’
    to_vessel = ‘nmr’
    volume = ‘9 mL’
    aspiration_speed = ‘10’
  />
  <RunNMR
    nmr=‘nmr’
    protocol=‘1D FLUORINE+’
    protocol_options=“{‘Number’: 64, ‘RepetitionTime’: 5,
    ‘AcquisitionTime’: 3.2,
    ‘PulseAngle’: 90}”
    comment=‘First Measurement’ />
  <Transfer
    from_vessel=‘nmr’
    to_vessel=‘CouplingFlask’
    volume = ‘10 mL’
  />
  <!-- Evaporation & Sublimation Steps -->
  <Confirm
    msg = ‘Ready for evaporation and sublimation?’
  />
  <SchlenkLineTapOpenVacuum
    pneumatic_controller=‘Line’
    port=‘1’
  />
  <StartStir
    vessel = ‘EvaporatingFlask’
    stir_speed =‘200’
  />
  <Transfer
    from_vessel=‘CouplingFlask’
    to_vessel=‘EvaporatingFlask’
    from_port=‘1’
    aspiration_speed = ‘1’
    volume = ‘100 mL’
  />
  <StartStir
    vessel = ‘EvaporatingFlask’
    stir_speed =‘500’
  />
  <SchlenkLineTapClose
    pneumatic_controller = ‘Line’
    port = ‘4’
  />
  <SchlenkFlaskTapOpen
    pneumatic_controller = ‘Line’
    position = ‘top’
  />
  <HeatChill
    vessel=‘EvaporatingFlask’
    temp=‘40’
    stir=‘true’
    stir_speed=‘420’
    time = ‘30 mins’
  />
  <SchlenkFlaskTapClose
    pneumatic_controller = ‘Line’
    position = ‘top’
  />
  <SchlenkLineTapClose
    pneumatic_controller = ‘Line’
    port = ‘1’
  />
  <SchlenkLineTapOpenVacuum
    pneumatic_controller=‘Line’
    port =‘4’
  />
  <Wait
    time = ‘10 mins’
  />
  <HeatChill
    vessel=‘EvaporatingFlask’
    temp=‘120’
    stir=‘true’
    stir_speed=‘320’
    time = ‘3 h’
  />
  <Confirm
    msg = ‘Sublimation complete?’
  />
  <SchlenkLineTapOpenArgon
    pneumatic_controller=‘Line’
    port=‘4’
  />
  <Confirm
    msg = ‘Disconnect Flask and analyse product’
  />
  </Procedure>
</Synthesis>
```

### 3.7 XDL Description for Preparation of [(Dipp)NacNac}Mg]₂

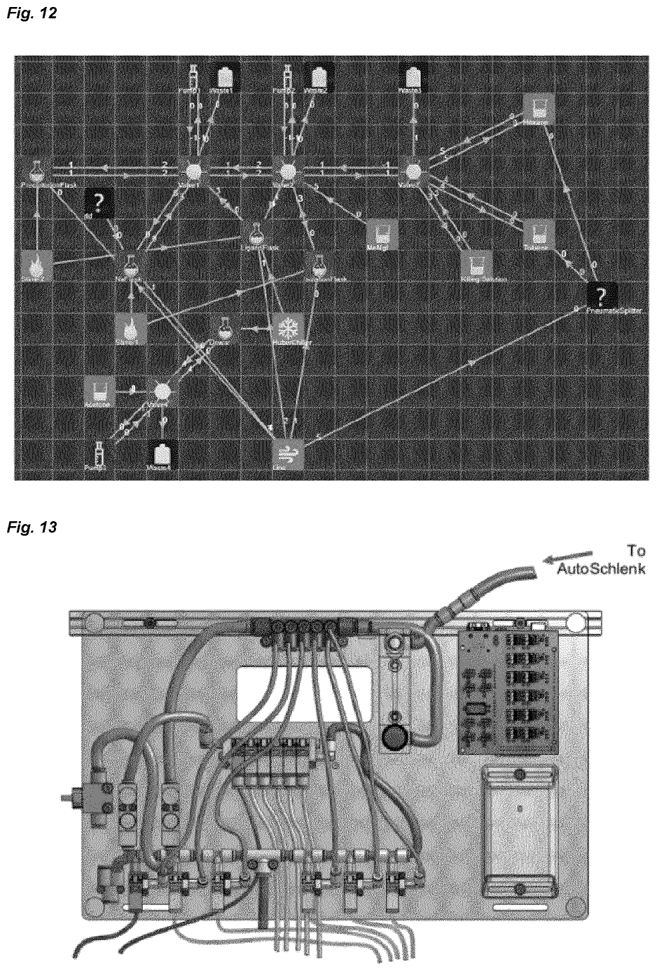

The following is the XDL file executed by the platform in concert with the graph shown in FIG. 12. The XDL file has three sections: Hardware, Reagents and Procedure. Comments are added for clarity of the reader.

An inert manifold (Schlenk line) consists of an array of taps connecting two gas/vacuum lines to tubing for connection to various flasks and reactors. To allow for flexibility in conducting manipulations each tap must be independently operable. Two common types of taps exist: double oblique taps which are rotated to provide a connection between the reactor and the respective manifold lines; or a pair of greaseless stopcocks (J Young®, Rotaflo® etc) which individually open the reactor to either the vacuum or gas line (or potentially even both if improperly used). In our work we elected to design a manifold based on the latter style with five reactor lines thus using ten Louwers Hanique vacuum taps (i.e., 5 pairs) (Brenninkmeijer et al.). These hollow glass taps can be linearly actuated by application of a weak positive or negative pressure (ca 50 mbar (5000 Pa)) to the hollow of the glass barrel, see FIG. 2a. Three O-rings provide a tight seal within the barrel towards the atmosphere with the terminal O-ring acting to open or close the system to the reactor depending upon the linear position of the barrel.

Control over the actuation of these taps was provided by utilising a programmable solenoid manifold consisting of 12 electromagnetic valves connected to a diaphragm pump and gas lines which when engaged were able to affect the opening and closing of each of these taps individually. Our Schlenkputer line, when coupled to a rotary vane pump can achieve ca 1.5×10⁻³ mbar (0.15 Pa) pressures and withstand at least 1 bar positive pressure of inert gas, see FIG. 2b. Using the combination of this technology the taps can be controlled using direct XDL commands such as “SchlenkLineOpenVacuum” (FIG. 2c) or these commands can be integrated to allow the use of high-level unit operations within the XDL file such as “EvacuateAndRefill” whereby the line is cycled automatically between opening the flask to the vacuum line and the gas line. In each case the length of time, cycle repeats and specific flask can be input as parameters with 3 mins vacuum, 2 mins gas and 3 repeats found to be optimal for inertization in our hands.

### Development of Automated Sealable Glassware for Inert Atmosphere Chemistry

In classical Schlenk chemistry, flasks are commonly opened under a flow of inert gas to allow the insertion of a cannula, usually through septa, for liquid transfer (Errington; Synthetic Methods of Organometallic and Inorganic Chemistry). However, the Chemputer liquid handling backbone does not require opening and closing during a reaction and as such, our inert atmosphere syntheses can in large part be carried out using commercial Quickfit® glassware such as round bottomed flasks. Despite this there is still a need to utilise automated Schlenk-type flasks in key places where sensitive reagents or reactants must be retrieved from a glovebox, where reactive products must be isolated as solids, or where the reactive species must be stored for long periods e.g., during crystallisation. In addition, there are some operations for which direct opening and closing of connections between one reactor and another may be required.

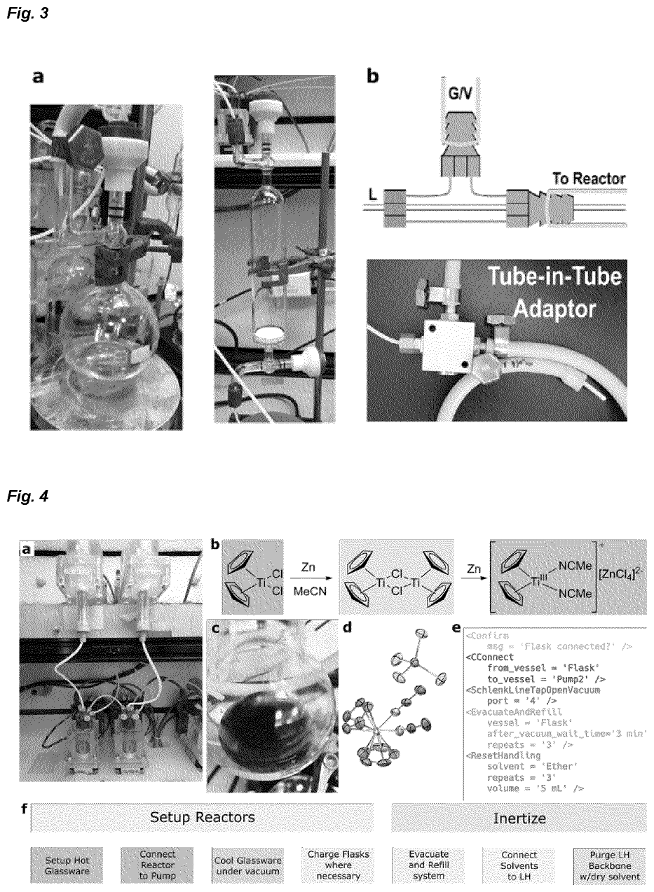

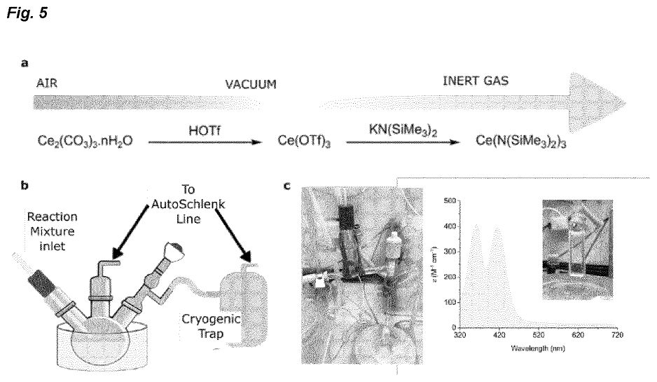

For these reasons we developed a set of key pieces of glassware to facilitate the full automation of our reactions, see FIG. 1, FIG. 3a. Each flask utilises the same remotely operable taps as the Schlenk line and is automatically controlled in a similar way. Chemically inert FFKM O-rings provide minimal swelling upon chemical or solvent exposure resisting at least 48 h submersion in solvent without loss of function. Firstly, an isolation flask was developed for collection of pure material, see FIG. 3a left. A 250 mL RBF with a single automated tap was designed and built. Solutions of product materials may be transferred into this flask through the liquid handling system and the solvent removed in vacuo allowing the solid material to be extracted in an inert atmosphere glovebox. Next a filtration flask, see FIG. 3a right, was produced, allowing separate inlet and outlet ports for isolation of solid material. The large volume allows crystallisation of the product in the flask or alternatively filtration through celite to remove particulate material. Finally, a single tap was appended to a Quickfit® joint for flexible use of a remotely operable filtration tap connected to a standard RBF, see FIG. 5e. This tap can be used to control the evaporation of solvent/reagents into an external cryogenic trap (for example in the Cerium(III) silylamide synthesis, below). The XDL commands SchlenkFlaskTapOpen and SchlenkFlaskTapClose were designed for use with any of this glassware. Up to two taps can be used in conjunction with the Schlenk line based on our current design.

Integration of the automated Schlenk line with liquid handling. Two different methods have been utilised for the integration of the gas handling system with the liquid handling backbone of the Chemputer. The simplest involves the use of multi-necked glassware fitted with both a liquid handling adaptor (B19 to GL14 adaptor for ⅛″ (3.175 mm) LH tubing) and a gas/vacuum adaptor (B24 to ¼ in. glass hose barb). However, this option does not allow for the facile, automated sealing of the vessel for transport to a glovebox or storage. The Schlenkputer glassware set we have described above (FIG. 3a) has been designed with only one inlet/outlet per tap (neck). For integration with these flasks a tube-in-tube design was utilised to allow both inertization and liquid handling through a single port (FIG. 3b).

This method has several advantages: first, these tube-in-tube adaptors can allow for connection of the inert manifold to liquid handling systems which are not designed with inertization in mind or allow the use of non-bespoke glassware; secondly, the adaptors can be connected in a daisy chain fashion thus making optimal use of the five manifold lines of the Schlenkputer; this setup also provides an additional safety feature for the handling of pyrophorics since any potential leaks in the LH tubing will only expose the system to inert gas rather than air.

A route-map style depiction of the integration of the hardware described herein with the previously reported liquid handling system of the Chemputer is shown in FIG. 1. Here, the solvent storage flasks, FIG. 1 pink, are connected to the Schlenkputer through a gas line splitter which means one manifold line can provide all the required solvents with a gas blanket. The Schlenk Filter Flask (FIG. 1 green, FIG. 3a right) described above is connected through a Tube-in-Tube adaptor on the top port but directly to liquid handling on the bottom while the Schlenk collection Flask (FIG. 1 teal, FIG. 3a left) only requires a single inlet position to transfer liquids in and to remove the solvents, allowing for collection of the solid reaction product. We have also designed a UV/vis cuvette (FIG. 1 orange, FIG. 5c) and J Young® tap NMR tube adaptor (FIG. 1 yellow) for our system to facilitate sampling during and after reactions. Finally, the alternate method of using a standard QuickFit® RBF allows for different necks to be connected to the liquid and gas handling manifolds respectively (FIG. 1 blue). The outlet port of the inert gas line on the Schlenkputer runs through the waste collection bottle and to a bubbler. This line can also be split to allow an inert gas flow over suba-sealed reagent bottles such as nBuLi.

### Periodic Table Flight

Having designed a programmable hardware and software system for inert atmosphere synthesis four sensitive compounds from across the periodic table were chosen to develop the Schlenkputer implementation focussing on control, reliability, safety, and interoperability. Each has a different sensitivity profile with some sensitive to oxygen, others moisture, as well as temperature and vacuum.

d-Block Complex—Titanocene

All known automated chemical systems exploit liquid handling (LH) pumps and valves in concert with reactors or flow loops to undertake the operations required for synthesis. For reactions involving highly sensitive reagents it is key that not only the reactor is inertized but that the entire system is free from oxygen and moisture thus strategies to fully inertize the LH system were investigated using [Cp₂Ti^{III}(MeCN)₂]⁺. The titanocene species [Cp₂Ti^{III}(MeCN)₂]⁺ is one of the most widely used colorimetric indicators (Yeung et al.; Burgmayer), turning from blue to yellow readily upon exposure to oxygen. In the first instance this reaction afforded us the opportunity to gain rapid feedback on our ability to exclude air from the pump-valve liquid handling system of the Chemputer. By transferring the blue solution through the sets of valves and pumps we could identify areas where simple cycling of the reactor flask was insufficient for an entire synthetic procedure.

We immediately identified the connections between the valves and pumps as well as the connections between individual valves as being ‘dead’ areas where out Schlenkputer line was unable to purge, see FIG. 4a. As such when transferring the blue titanocene solution between valves rapid decolourisation was observed. To address this, we adopted two complementary approaches which can both be used to inertize liquid handling systems: 1) When inertizing a reactor flask the liquid handling tubing connecting the glassware and the valve was naturally evacuated since it was open to the flask. By also turning the valve to the appropriate reactor position to open the connection between the pump and the flask before inertization we were able to remove air from these lines (FIG. 4a, yellow). 2) Removing air from the connection between valves (FIG. 4a, green) was more challenging since, in our system, these could not be directly connected to the flask and thus to the Schlenk line. Instead, these short tubes were purged by transferring dry solvent through the full liquid handling backbone in triplicate. With these measures in place both the flasks and liquid handling system were demonstrated to be free from oxygen by repeated transfer of the colorimetric indicator throughout the system (FIG. 4c).

The synthetic protocol for the synthesis of [Cp₂Ti^{III}(MeCN)₂]⁺ involves the suspension of the air stable bis(cyclopentadienyl)titanium(IV)chloride in acetonitrile followed by reduction over solid Zinc dust (FIG. 5b). During the reduction the red solution turns first green, then deep royal blue in the absence of air however oxygen exposure results in rapid decolourisation. In order to achieve the automated synthesis and isolation of the product in this case the reaction was setup to involve two RBFs and one crystallisation (Schlenk) flask (FIG. 3a). Each RBF was charged with one of the solid reagents (Cp₂TiCl₂ or Zn dust).

The automated procedure prompts the user to charge the flask at the appropriate time (i.e., once the flask has cooled) and when addition has been confirmed the automated run continues. In this way the reaction setup is guided and assisted by automation, but the reaction process is fully automated after run setup which takes approx. 15-20 mins (FIG. 4e-f).

The Cp₂TiCl₂ is then dissolved in acetonitrile before the red solution is transferred to the Zn containing flask with stirring for 30 mins. The resultant blue solution is transferred through the liquid handling backbone to the Schlenk Flask whereupon the top Louwers Hanique tap has been automatically opened. Next the Schlenk Flask is charged with dry Et₂O and the flask sealed for 48-72 h during which time the solution remained deep blue. Finally, the bottom tap on the Schlenk flask is opened to pump out the mother liquor and yield the crystalline product on the Schlenk Flask filter frit. These crystals can be isolated for XRD analysis by pumping Fomblin Y oil automatically into the Schlenk Flask, thus providing some protection from air upon retrieval of the crystals. In our case XRD analysis demonstrated the formation of the target compound by comparison with published structures (FIG. 4d).

f-Block Complex—Luminescent Cerium Silylamide

Lanthanide coordination chemistry is another field which has seen significant application of inert-atmosphere techniques (Day et al.; Nicholas et al.). Whilst most lanthanides exist almost exclusively in the 3+ oxidation state Cerium is one of the few which, in addition to undergoing rapid ligand hydrolysis, is readily oxidised in air to Ce(IV) owing to its position within the 4f block. In our next experiment we targeted a widely used cerium amide which has been previously shown to exhibit luminescent properties, but which can also act as a precursor for a wide range of novel lanthanide species (Yin et al.). For inert and anhydrous chemistry on salts to succeed it is vital that the precursors reagents are free from water coordination, as in the titanium example above. However, electropositive metals such as those of the f-block are highly hygroscopic yielding very stable hydrated species rapidly in air. The reagents required to dehydrate metal salts (e.g. HX acids, SOCl₂, TMSCl and Tf₂O) are often highly corrosive, and could be detrimental to our automated systems, therefore, our ability to automate the handling of these compounds was investigated.

Addition of excess neat triflic acid to an aqueous suspension of Ce₃(CO₃)₂ was undertaken using the liquid handling backbone of the Schlenkputer under air (FIG. 5a). The resulting acid suspension was first refluxed (100° C.) in an RBF connected through a Findenser™ to the Schlenkputer bubbler. This allowed us to investigate the effect of the acid on both the liquid handling hardware and the Schlenkputer O-rings. Visual inspection showed no impact of either the liquid transfer or refluxing of the acid solution. After automated workup, IR Analysis demonstrated that the resulting CeOTf₃ was free of hydration by the absence of the key —OH band at ca 1650 cm−1 (cf. 1657 cm⁻¹ in CeOTf₃·xH₂O) (Sofield et al.).

Our adapted literature procedure for the synthesis of Ce(N(SiMe₃)₂)₃ consisted of the salt metathesis reaction of anhydrous Ce(OTf)₃ with KN(SiMe₃)₂(KN″) in THF, yielding highly soluble CeN″3 as a yellow solid (see Rees et al.). Replacement of the THF solvent with hexane, by evaporation under reduced pressure is a key step in the isolation the highly soluble product from solvated side products. In organic chemistry a rotary evaporator may be automated to allow for removal of solvent (Burger et al.; Angelone et al.), however, the pressure obtainable in these systems is usually insufficient to obtain a robustly inert system meaning an alternate solvent removal route is required for the Schlenkputer. After mixing of THF solutions of the cerium salt and silylamide base the solvent was removed by connection of an automatically controllable Louwers Hanique side arm to a cryogenic trap which was maintained under dynamic vacuum, using the Schlenkputer, for 16 h (FIG. 5b). This external cryogenic trap is like the inline trap of the Schlenkputer however the ability to isolate this trap from the reactor by means of the automated side arm is vital to allowing subsequent manipulations without manual intervention. In this case, after automated THF removal the residue was extracted with hexanes and transferred (through a filter-tipped tube) to a collection flask whereby the solvent was removed under reduced pressure to yield pure Ce(N(SiMe₃)₂)₃ (compound 2).

Since this cerium complex also exhibits a characteristic yellow colour, indicative of the Ce(III) oxidation state, we sought to include analytical sampling in our process. A quartz cuvette was designed which allowed facile connection to both the liquid and gas handling systems of our Schlenkputer whilst also being sealable for transport to the relevant spectrometer (FIG. 5c). UV/Vis analysis of the yellow solution was in keeping with published spectra (Yin et al.). Subsequent exposure of the sample to air for a brief period (ca 3 secs) resulted in immediate darkening of the solution to deep orange/brown demonstrating this compounds high reactivity towards air. NMR sampling was also developed and explored for both CeOTf₃ and CeN″₃. In each case a capillary of deuterated solvent was placed in the NMR tube before it was appended to the Schlenkputer followed by semi-automated transfer of the analyte solution (semi-automated since J Young® tap NMR tubes themselves have not been automated herein). Analytically sampled NMR spectra were in keeping with those collected within an inert atmosphere glovebox.

p-Block Compound—Tris(pentafluorophenyl)borane

Tris(pentafluorophenyl)borane (BCF) is a highly moisture sensitive Lewis acid (Lawson et al.). Accessed through the formation of an aryllithium intermediate, BCF, like many organometallics or other highly-reactive species, is commonly synthesised at very low temperatures (<−70° C.). In addition the final product is often purified by sublimation to separate the organic product from LiCl and other impurities, a process which has not previously been automated. This borane also has several valuable NMR handles which can be used to accurately determine the degree of water coordination should the system be exposed to moisture due to dramatically different resonance shifts in the 3- and 4-coordinate examples (FIG. 6a). In order to achieve this synthesis in an automated fashion we therefore required the incorporation of an automated chilling system which was able to reach temperatures as low as −90° C., a sublimation protocol for purification of the product under inert conditions and we elected to include inline NMR analysis to provide rapid feedback on the formation of the anhydrous product. Two key reagents for this procedure, n-BuLi and BCl₃ were purchased as solutions and connected directly to the nitrogen and liquid handling systems using needles to minimise the requirement for bespoke equipment. Lithiation and coupling were carried out in a single flask which was cooled to −80° C. automatically (FIG. 6b) before the temperature was autonomously raised to ambient over a period of 120 mins. A portion of the reaction mixture was then transferred to the flow NMR cell appended to the Schlenkputer and subject to ¹⁹F NMR which demonstrated formation of the desired product (Fischer et al.), distinct from the unwanted aquo adduct (−135, −155, −163 ppm) which was not observed (FIG. 6c) (Berguist et al.; Baumgarth et al.).

Pure, colourless tris(pentafluorophenyl)borane is most commonly obtained through inert-atmosphere sublimation to separate the product from LiCl and other impurities (Bismuto et al.). For manual sublimation it is common to charge a sublimation tube with a solid crude product which can then be heated under vacuum and condenses on either a second room temperature tube or on a cold finger. In order to eliminate this manual step we elected to transfer the product solution into a flask and remove the solvent in situ. The reaction mixture was thus transferred into a 3-necked RBF appended with an external cryogenic trap for automated solvent removal (FIG. 6d/e). As for CeN″3 above, this strategy meant that the solvent could be removed and then isolated in the trap allowing a vacuum pressure sufficient for sublimation to be achieved within the RBF.

The dried residue was then sublimed into a collection flask which was connected to the central neck of the RBF. An inverted Schlenk flask was utilised to collect the pure product for three reasons: 1) the Schlenk side arm could be used to pull vacuum from the Schlenk line thus reducing the pressure in the flask to allow sublimation; 2) the male joint on the flask could be readily connected to the RBF, with the tube providing a cool surface for the product to condense on; and 3) importantly, the side arm can also be used to purge with an inert gas at the end of the procedure which allows capping of this flask for transfer to a glovebox for product collection and storage. The isolated material showed ¹⁹F NMR resonances at −128.8, −141.6 and −159.9 ppm with an ¹¹B resonance at 59.6 ppm each indicative of 3-coordinate boron.

s-Block Complex—Mg(I) Dimer Accessing usual or relatively unstable oxidation states is one common theme in modern organometallic and inert-atmosphere chemistry and is often achieved by exploiting the reducing power of alkali metals (Nagendran et al.; MacDonald et al.; Rösch et al.). However, their use in organic solvents can present hazards which makes their automation challenging. We sought to undertake an alkali metal reduction reaction to yield Stasch & Jones' Mg(I) dimer (Green et al.) utilising our Schlenkputer system (FIG. 7a) providing a safe method for reacting with, and quenching Na(0) in automation. Herein we demonstrate mitigation of this risk by use of a temperature probe for real-time feedback upon automated quenching of the alkali metal. For our purposes we can consider the synthesis of Mg(I) as consisting of sets of operations running alongside each other: the Mg(II) reduction and the Na(0) handling. The first step in the magnesium reduction requires the metalation of the DippNacNac ligand (L) to yield moisture and vacuum sensitive LMgI(OEt₂)ₙ (FIG. 7a). limit the temperature to 50° C. total such that a runaway reaction with evaporation of solvent does not occur.

As for other solid reagents, during setup an RBF was manually charged with the solid ligand (L) while another was similarly charged with a dispersion of Na(0) in oil before cycling of the entire system. Subsequent automated addition of MeMgI in toluene (3 M) at −30° C. yielded a pale yellow solution. Due to the small volume of MeMgI solution added (680 μL) the liquid handling tubing (between valve and reactor) was flushed with additional toluene solvent (7 mL) to ensure stoichiometric reaction. Next the sodium metal was washed clean of oil using hexane and the filtrate transferred to the waste flask which was maintained under a stream of N₂ for safety (FIG. 7b). The toluene solution of LMgI(OEt₂)n was transferred onto a suspension of Na(0) in toluene and the mixture stirred overnight. The solution was then automatically filtered and extracted into hexane to yield the product dimer [(DippNacNac)Mg]₂, which was confirmed by NMR and XRD analysis.

Before the automated reaction run was completed however, the pyrophoric sodium metal was quenched while maintaining the solution temperature below 50° C. to reduce risk. In order to determine the safest addition rate, we carried out the Na quenching at various

1. An automated chemical synthesiser for anaerobic and/or anhydrous chemical synthesis, the synthesiser comprising a first reactionware in fluid communication with a reagent manifold, a vacuum line and a gas line, wherein the synthesiser further comprises a control unit for automatically and independently controlling fluid communication of the reactionware with the reagent manifold, the vacuum line and the gas line, and the gas line is for the supply of anaerobic and/or anhydrous gas.

2. The automated chemical synthesiser according to claim 1, the synthesiser further comprising a second reactionware, wherein the second reactionware is in fluid communication with the reagent manifold, the vacuum line and the gas line, and the control unit is for automatically and independently controlling fluid communication of the second reactionware with the reagent manifold, the vacuum line and the gas line, wherein the second reactionware is in fluid communication with the first reactionware via the reagent manifold, and the second reactionware is isolable from the first reactionware.

3. The automated chemical synthesiser according to claim 1, the synthesiser comprising one or more further reactionware wherein each of the one or more reactionware is independently in fluid communication with the reagent manifold, the vacuum line and the gas line, and the control unit is for automatically and independently controlling fluid communication of each of the one or more reactionware with the reagent manifold, the vacuum line and the gas line, wherein each of the one or more reactionware is in fluid communication with the first and/or the second reactionware via the reagent manifold, and each of the one or more reactionware is isolable from the first and/or second reactionware.

4. The automated chemical synthesiser according to claim 2, wherein the reagent manifold comprises a valve in line with the fluid communication of one reactionware with another reactionware, wherein the valve is automatically operable to control fluid communication between the reactionware.

5. The automated chemical synthesiser according to claim 1, wherein the synthesiser further comprises a Schlenk line for independently providing to each reactionware vacuum from the vacuum line, gas from the gas line and to isolate the reactionware from the vacuum line and the gas line.

6. The automated chemical synthesiser according to claim 5, wherein the Schlenk line has valves for controlling the provision of vacuum and gas and for isolation control, and the valves are controllable by pressure change switching.

7. The automated chemical synthesiser according to claim 5, wherein the Schlenk line has valves for controlling the provision of vacuum and gas and for isolation control, and the valves are solenoid valves controllable by electronic signalling.

8. The automated chemical synthesiser according to claim 7, wherein the Schlenk line comprises two valves per line, and the two valves are configured to control the provision of vacuum and gas and for isolation control.

9. The automated chemical synthesiser according to claim 1, wherein at least one reactionware has a port for delivery and removal of fluids to and from the reactionware, wherein the port holds a first fluid delivery line which holds a second fluid delivery line, and the first fluid delivery line is for vacuum from vacuum line or gas from the gas line, and the second fluid delivery line is in fluid communication with the reagent manifold.

10. (canceled)

11. The automated chemical synthesiser according to claim 1, wherein the gas line is for the supply of gas at atmospheric pressure (101 kPa) or above.

12. The automated chemical synthesiser according to claim 1, wherein
the gas line is for the supply of gas having a water content of 100 ppm or less; or
the gas line is for the supply of gas having an oxygen content of 100 ppm or less.

13. (canceled)

14. The automated chemical synthesiser according to claim 1, wherein the vacuum is for providing a reduced pressure within a reactionware.

15.-16. (canceled)

17. The automated chemical synthesiser according to claim 1, wherein a reactionware is provided with a cold surface, for the collection of sublimate, and the cold surface is a part of the reactionware and is separable from other parts of the reactionware.

18. The automated chemical synthesiser according to claim 1, wherein
a reactionware is isolable from the reagent manifold, the vacuum line and the gas line; or
a reactionware is separable from fluid communication with the reagent manifold, the vacuum line and the gas line.

19. (canceled)

20. The automated chemical synthesiser according to claim 1, the synthesiser further comprising an analytical unit for automatic analysis of a reaction mixture in a reactionware.

21.-22. (canceled)

23. A method for performing an anaerobic and/or anhydrous chemical synthesis in an automated chemical synthesiser according to claim 1, the method comprising the step of:
(i) supplying, under the autonomous control of the control unit, an anaerobic and/or anhydrous gas from the gas line to reactionware; or
(ii) applying a vacuum, under the autonomous control of the control unit, from the vacuum line to the reactionware.

24. The method of claim 23, the method comprising the step of (ii) applying a vacuum, under the autonomous control of the control unit, from the vacuum line to the reactionware; and subsequently (i) supplying under the autonomous control of the control unit, an anaerobic and/or anhydrous gas from the gas line to reactionware.

25. The method of claim 23, further comprising the step (iii) of supplying to the reactionware, under the autonomous control of the control unit, one or more reagents, from the reagent manifold,
wherein step (iii) follows after either a step (i) or a step (ii), or a step (iii) is followed by a step (i) or a step (ii).

26. The method of claim 25, further comprising the step (iv) of performing a reaction in a reaction space of the reactionware.

27. The method of claim 23, the method comprising the step of automatically measuring and/or controlling, under the autonomous control of the control unit, one or more of:
(a) the water content in the atmosphere of a reaction space of the reactionware;
(b) the oxygen content in the atmosphere of a reaction space of the reactionware;
(c) the pressure of the atmosphere of a reaction space of the reactionware.
